(19) United States
(12) Patent Application Publication
(10) Pub. No.: US 2026/0301566 A1
(43) Pub. Date: Oct. 1, 2026

(54) DRIVING SCENE SIMILARITY CONFIRMATIONS

(71) Applicant: Zoox, Inc., Foster City, CA (US)

(72) Inventors: Muhammad Umar Choudry, Seattle, WA (US); Meredith James Goldman, Redwood City, CA (US); Jeffrey Loris Irion, Castro Valley, CA (US); Vishaal Samir Saraiya, Foster City, CA (US)

(21) Appl. No.: 19/096,458

(22) Filed: Mar. 31, 2025

(51) Int. Cl. G08G 1/09; G08G 1/16

(52) U.S. Cl. CPC G08G 1/09; G08G 1/164

(57) ABSTRACT

Aspects of this disclosure relate to proactively transmitting resolution data to vehicle(s) in an environment that experience the same or similar uncertain sensor data. More specifically, aspects of this disclosure related to receiving, from a first vehicle, a confirmation request associated with first sensor data perceived in an environment (e.g., about which the first vehicle lacks sufficient confidence). Appropriate resolution data may be determined for the first sensor data (e.g., by a remote operations system), and may be transmitted to the first vehicle. Based on context data (e.g., location, position, orientation, perception) associated with a second vehicle, a likelihood that the second vehicle will perceive second sensor data that is similar to or the same as the first sensor data may be determined. Based on the likelihood, the resolution data may be transmitted to the second vehicle so that it is better equipped to navigate the second sensor data.

### BACKGROUND

Autonomous and semi-autonomous vehicles may encounter complications or unexpected obstacles while operating in an environment, such as rare or anomalous objects perceived by the vehicle sensors that cannot be identified by the on-vehicle systems with sufficient confidence. In response to such complications or obstacles, the vehicle may request assistance or guidance from a remote operations component that may analyze the sensor data captured by the vehicle and identify the anomalous objects/driving scenes. Such remote operations assistance may improve autonomous vehicle decision making and safety outcomes but can be time-consuming and resource-intensive which may increase driving trip time and reduce driving efficiency in some cases.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example framework associated with multiple vehicles perceiving the same or similar uncertainties and receiving resolution data to address the uncertainties, in accordance with examples of the disclosure.

FIGS. 2A and 2B illustrate an example process in accordance one or more of the techniques discussed herein.

FIG. 3 illustrates an example framework configured to implement one or more of the techniques discussed herein.

FIG. 4 illustrates an example machine-learned framework configured to implement one or more of the techniques discussed herein.

FIG. 5 illustrates an example environment configured to implement one or more of the techniques discussed herein.

FIG. 6 illustrates an example system in accordance with the techniques described herein.

### DETAILED DESCRIPTION

This application relates to techniques for improving vehicle operations systems by increasing the efficiency and accuracy with which uncertainties or ambiguities experienced by vehicle(s) navigating an environment are reviewed and addressed. More specifically, the techniques of this application relate to efficiently providing guidance and/or context (e.g., resolution data) to vehicle(s) operating in an environment which may perceive the same or sufficiently similar sensor data. The techniques herein relate to processes, methods, and frameworks for an improved vehicle operations system configured to proactively provide resolution data to vehicles such that they are prepared and equipped to navigate the same or similar uncertainties in an environment perceived by other vehicles. In other words, this application relates to improving the efficiency, reliability, and safety of vehicle operations systems by reducing the amount of time and resources allocated to monitoring vehicle(s) and to analyzing and responding to requests for scene confirmation transmitted by vehicle(s) operating in an environment. “Sensor data” as used herein denotes the myriad circumstances, features, characteristics, and/or uncertainties associated with an environment proximate a vehicle which may cause the vehicle to lack sufficient confidence to proceed nominally. For purposes of clarity and not limitation, “sensor data” may comprise data perceived or determined by one or more sensor(s) associated with the vehicle which cause the vehicle to lack sufficient confidence and/or to determine that guidance/context from a remote operations system would improve vehicle functionality. “Resolution data” as used herein denotes the myriad tools, methods, and/or techniques that may be deployed or leveraged by a remote operations system to clarify, resolve, and/or obviate sensor data perceived by a vehicle. For example, “resolution data” may comprise suggested action(s) (e.g., trajectory modification, acceleration profile modification, ‘go slow’ instruction, nudge forward/backward, avoid geolocation associated with the sensor data, pull over), sensor data modification(s) (e.g., identify and/or classify unknown object(s), clarify that an obstacle is partially or fully occluded), selection of one or more responses associated with a request for scene confirmation (e.g., an answer to a multiple-choice question, a selection of “yes” or “no”) and/or any other action, information, data, instruction, etc., likely to resolve the sensor data. As discussed in more detail below, the vehicle may receive the resolution data and validate or confirm its feasibility and safety prior to implementing it.

In some examples, a first vehicle may transmit a request for guidance and/or scene confirmation in response to perceived sensor data that the vehicle is not sufficiently confident about (e.g., a confidence level that a flagger in a construction zone is showing a “slow” sign fails to meet a threshold confidence). The request for scene confirmation may be received by a remote operations system. In some examples, the request for scene confirmation may be received by a remote operations system, and may comprise context data (e.g., location, position, orientation) associated with the perceived sensor data. The remote operations system (e.g., which may include various automated vehicle teleoperations tools and/or human remote operators) may determine resolution data (e.g., suggested action, selection of a response), and may transmit the resolution data to the first vehicle. The first vehicle may interpret the resolution data, verify or validate it (e.g., confirm that it is practical and safe), and determine whether to implement it to navigate the perceived sensor data.

In examples, a second vehicle operating in an environment (e.g., the same or a different environment) may determine a route from a starting location to a destination location. Based at least in part on the route of the second vehicle and the context data associated with the sensor data perceived by the first vehicle, a computing resource (e.g., a planning component of the second vehicle or remotely accessible to the second vehicle) may determine that a likelihood the second vehicle will perceive the same sensor data meets or exceeds a threshold likelihood (e.g., based on a location associated with the construction zone flagger and the second vehicle's route). In other examples, the computing resource may determine a similarity metric of second sensor data perceived by the second vehicle as compared to the sensor data perceived by the first vehicle. The similarity metric may be used at least in part to determine a likelihood that the second vehicle will perceive second sensor that is the same as or is sufficiently similar to the sensor data perceived by the first vehicle. If the likelihood meets or exceeds a threshold likelihood, the computing resource may transmit the resolution data that resolved the sensor data for the first vehicle to the second vehicle such that the second vehicle may navigate the second sensor data with minimal or no disruption. That is, the computing resource may, in such an example, determine resolution data associated with the perceived sensor data such that the second vehicle is better equipped to resolve the perceived sensor data, without intervention or assistance by a remote operator.

Techniques of this disclosure relate to improving the efficiency and accuracy with which the second vehicle (and additional third vehicle(s)) is equipped to navigate the same or similar sensor data. Further, techniques of this disclosure relate to reducing the second vehicle's reliance on a remote operator to navigate ambiguous or uncertain environments.

As a nonlimiting example for the sake of illustration, a first vehicle navigating an environment may perceive a stop light along a road that was previously unknown (e.g., was not stored in annotated map data because it was recently added to an intersection). The first vehicle may lack sufficient confidence about the stop light and may transmit a request for scene confirmation. A remote operations system may receive the request for scene confirmation and context data associated with the request and sensor data (e.g., location, position, and orientation of the vehicle relative to the sensor data). In some examples, the request for scene confirmation may comprise a yes/no question (e.g., “is the approaching traffic light flashing?” where the response options are “yes” or “no”), and the remote operations system may, based on the context data, determine appropriate resolution data (e.g., a confirmation of whether the light is flashing or not).

In other examples, the request may comprise a multiple-choice or selected-response question (e.g., “what color is the flashing light?” where the response options are “red,” “yellow,” “not flashing,” or “unsure.”). In yet other examples, the request may be open ended, meaning it may not list or provide response options, and may instead allow for a text response (e.g., “what road feature is ~10 m forward?”) or other resolution data. A remote operator (e.g., associated with the remote operations system) may receive the request and determine that the appropriate resolution data (e.g., selected response option, suggested action, etc.) is to confirm that the traffic light is flashing red. The resolution data may be transmitted to the first vehicle such that the first vehicle can confirm/validate the resolution data and implement it in order to navigate the traffic light. The first vehicle may transmit an indication that the resolution data successfully resolved the perceived sensor data, and the remote operations system may update map data associated with the traffic light such that other vehicles in the environment are aware of the traffic light and are more confident about how to navigate it.

In keeping with the above example, a second vehicle may be navigating the same environment. The techniques herein may determine that the second vehicle is sufficiently likely to perceive the same traffic light or a sufficiently similar traffic light. For example, the second vehicle may be communicatively coupled to or have access to a remote computing resource storing updated map data and may determine that a planned route implicates the same traffic light (e.g., based on a location of the traffic light along the route). The techniques herein provide for an at least partially automated method and system for the second vehicle to proactively determine how to navigate the traffic light.

For the purpose of this discussion, “map data” may comprise any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: texture information (e.g., color information (e.g., RGB color information, Lab color information, HSV/HSL color information), and the like), intensity information (e.g., LIDAR information, RADAR information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, map data may include a three-dimensional mesh of the environment. In some instances, map data may be stored in a tiled format, such that individual tiles of the map represent a discrete portion of an environment, and may be loaded into working memory as needed, as discussed herein. In at least one example, the map data may include at least one map (e.g., images and/or a mesh). In some examples, the vehicle may be controlled based at least in part on the map data. In some examples, map data may be stored on a remote computing device(s) accessible via network(s). In some examples, multiple maps may be stored based on, for example, a characteristic (e.g., type of entity, time of day, day of week, season of the year, etc.). Storing multiple maps may have similar memory requirements but increase the speed at which data in a map may be accessed.

For example, the techniques discussed may determine a likelihood that the second vehicle will perceive the same or sufficiently similar (e.g., with a similarity metric above a threshold similarity) sensor data as the first vehicle. The likelihood may be determined based on context data (e.g., location, position, orientation), annotated map data, and/or myriad other features or characteristics associated with the sensor data. The likelihood may be determined by the second vehicle (e.g., comparing a planned route to annotated map data along the route), or by a remote computing resource configured to monitor one or more vehicles operating in an environment (e.g., a fleet). Based at least in part on the likelihood meeting or exceeding a threshold likelihood, the resolution data that resolved the sensor data for the first vehicle may be transmitted to the second vehicle before the second vehicle perceives the sensor data. Additionally or alternatively, transmitting the resolution data to the second vehicle may be based at least in part on the indication received from the first vehicle that the resolution data successfully resolved the sensor data. In other words, transmitting the resolution data to the second vehicle may be based at least in part on determining that the resolution was appropriate and successful for resolving the sensor data for the first vehicle, and that the second vehicle is sufficiently likely to encounter or perceive the same or similar sensor data.

In at least some examples, transmitting the resolution data to the second vehicle may be further based on determining whether the resolution data is valid. For example, resolution data as it applies to a specific uncertainty in the environment may remain valid for a defined time window. As a more concrete nonlimiting example, if the first vehicle was uncertain about a flagger at a construction zone and received a suggested action that was sufficient to resolve the uncertainty, the suggested action may remain valid with respect to the flagger only for a predefined time window (e.g., 1 hour, 24 hours, 48 hours, one week). Transmitting the suggested action to the second vehicle may be based at least in part on determining whether a time that the second vehicle is likely to perceive the flagger is within the predefined time window. In such an example, the time window may be associated with the flagger and/or with other context data associated with the uncertainty.

Additionally or alternatively, resolution data associated with sensor data may be configured to time out or otherwise expire after a determined duration. In such an example, the resolution data may be applicable to the same or similar circumstances for a determined duration. As a more concrete nonlimiting example, if streetlights within a geofence associated with multiple vehicles lose power or otherwise become nonfunctional (e.g., because of construction), the vehicle(s) may transmit numerous requests for scene confirmation. Each request for scene confirmation may be similar or related in that they each indicate an uncertainty of whether the streetlights at any given intersection in the geofence are flashing red (e.g., the vehicle(s) expected to perceive functional streetlights). In such an example, resolution data transmitted to one of the vehicles that successfully resolved the uncertainty for that vehicle may be “reused” for other sufficiently similar requests received from other vehicles within the duration. For example, the remote computing resource may determine that one or more other requests from other vehicles in the same geofence also pertain to whether a perceived streetlight is flashing red or not. In such an example, based at least in part on the similarity of requests and the context data associated with each (e.g., the time associated with each request and the power outage in the area), the same or similar resolution data may be transmitted to the other vehicles in the fleet. Determining to transmit the resolution data to the other vehicles may be based on determining that the other requests were received within a duration associated with the traffic light(s) from when the resolution data successfully resolved the first uncertainty (e.g., within 1 minute, 5 minutes, 1 hour, etc.). Doing so may help prevent stale or expired resolution data. Further, such techniques may improve the functionality of vehicle(s) in the environment and may reduce the time and resources spent on analyzing and responding to requests for scene confirmation, thereby helping to facilitate a one-to-many remote operations system (e.g., where one remote operator is capable of monitoring many vehicle(s) in the environment).

In some examples, a vehicle applying the resolution data to similar sensor data may reset a duration of validity associated with the resolution or with the sensor data. For example, a vehicle that successfully resolves sensor data using retrieved or received resolution data may restart a duration associated with the resolution data. In such an example, the duration may start over and the resolution data may remain valid for an additional duration cycle.

In some examples, the resolution data may be transmitted to the second vehicle prior to the second vehicle perceiving the same or similar sensor data. In other words, the resolution data may be transmitted to the second vehicle proactively or preemptively such that the second vehicle is more confident about and better equipped to navigate the sensor data. Doing so may reduce the likelihood that the second vehicle transmits a request for scene confirmation and may improve the second vehicle's ability to navigate the uncertainty without guidance or context from a remote operator.

In some examples, the second vehicle may transmit an indication that the resolution data received was sufficient to successfully resolve or navigate the sensor data received by the second vehicle. In some such examples, a remote computing device (or, e.g., the second vehicle) may update the map data based on the indication received from the second vehicle. By updating the map data, other vehicles in the environment may be capable of leveraging the same or similar resolution data to navigate the sensor data previously resolved. In other words, if the resolution data is successful in resolving the uncertainty for a first vehicle and a second vehicle, a remote computing resource may determine that other vehicles in the environment may benefit from the resolution data and how it applies to the sensor data. Doing so may reduce the likelihood and/or frequency of requests for remote operator assistance with respect to the same or similar sensor data, thereby improving the functionality and efficiency of vehicle operations systems. Moreover, doing so may improve a vehicle operations system (e.g., an individual vehicle or a system configured to operate multiple vehicles) by facilitating a one-to-many remote operations environment, where an individual remote operator can more effectively allocate resources to a plurality of vehicles operating in an environment.

The techniques described may be implemented in a number of ways and contexts. For example, although discussed herein for purposes of illustration as being applied to a first vehicle and second vehicle, the techniques may be applied to any number of first vehicles, second vehicles, and so on. In other words, the techniques herein may be applied to any one or more vehicles (e.g., in a fleet of vehicles) operating in an environment. Additionally or alternatively, although many of the examples herein are described from the perspective of a remote operations system, any of the techniques, methods, or processes discussed may be applied or implemented by a vehicle. For example, the techniques discussed may be implemented in one or more components or systems local to a vehicle. Myriad additional and alternative use cases are contemplated herein.

In at least some examples, the techniques, processes, and methods of this disclosure may additionally or alternatively be applied after a vehicle experiences an uncertainty. Although many of the examples are discussed in the context of vehicle(s) experiencing uncertainties and transmitting confirmation requests while navigating an environment (e.g., in real time), the techniques of this disclosure may be just as well applied in a retroactive manner, after the vehicle(s) have experienced the uncertainties. For example, a remote operations system may analyze vehicle scenarios on a daily or weekly basis to determine what caused confirmation request(s) during vehicle scenario(s), what the outcome of the scenario(s) was, and/or how or why the outcome was the result of the vehicle's navigation of the environment. The techniques may be applied retroactively to vehicle scenarios (e.g., as determined by log data) to improve the functionality, reliability, and efficiency of the overall vehicle system architecture.

Further, although discussed in the context of vehicle(s), the methods, systems, and techniques described herein may be applied to a variety of systems or contexts and are not limited to autonomous or semi-autonomous vehicles (e.g., mobile robots). The examples provided herein are merely provided for purposes of clarity and are intended to be illustrative rather than limiting. One of ordinary skill in the art will understand and appreciate that the techniques discussed herein may be applied to a wide variety of contexts (e.g., other machinery or robotics, warehouse logistics, etc.). Example implementations are provided below with reference to the following figures.

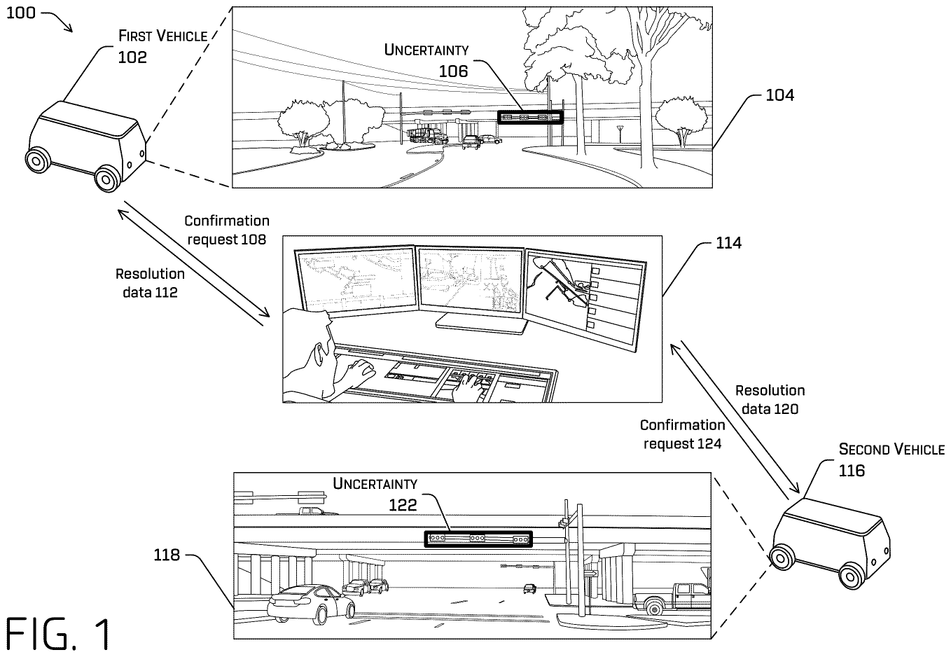

FIG. 1 illustrates an example environment 100 configured to implement one or more of the techniques discussed herein. For instance, example environment 100 may comprise a first vehicle 102 operating in an environment 104. In some examples, the first vehicle 102 may be a real vehicle operating in a real-world environment. In other examples, the first vehicle 102 may be a simulated vehicle operating in a real-world environment. In other examples, both the first vehicle 102 and the environment 104 may be simulated. The techniques discussed herein may be applied to any combination of real, simulated, and/or hybrid environments and/or vehicles.

In some examples, the first vehicle 102, while navigating the environment 104, may perceive sensor data about which it lacks sufficient confidence to proceed. For example, the first vehicle 102 may encounter uncertainty 106. As depicted for purposes of illustration and not limitation, uncertainty 106 may be a road feature (e.g., traffic light) that was not previously known or perceived by the first vehicle 102. For example, uncertainty 106 may have recently been installed or altered, meaning the first vehicle 102 may not have expected to perceive the uncertainty 106. Such may be the case where annotated map data associated with the first vehicle 102 (e.g., stored locally on the vehicle or remotely accessible to the vehicle) may not have been updated to indicate the existence of the road feature.

In other examples, uncertainty 106 may be a temporary hazard or feature of the environment 104. For example, uncertainty 106 may be a flagger in a construction zone, a modified or unexpected lane marking, a vehicle or obstacle pulled over to the side of the road, and so on. Although depicted as a streetlight, uncertainty 106 may be any permanent or temporary characteristic, element, or feature of the environment 104 which causes the first vehicle 102 to lack sufficient confidence about its perceived sensor data. There are many issues, obstacles, road features, objects, etc., that may cause the first vehicle 102 to lack sufficient confidence about its sensor data. New or modified road features may be unexpected (e.g., may not be stored in map data), weather conditions or poor visibility (e.g., steam, dust, smoke, glare from oncoming headlights), sensor disruptions (e.g., blocked or dirty sensors, reflections from glass buildings or wet roads), ambiguous or unexpected roads (e.g., faded or unmarked road lines, construction zones, temporary barriers, unusual road signs), unpredictable traffic behavior (e.g., erratic vehicles, unpredictable pedestrians/cyclists, animals crossing a road), legal or ethical uncertainties (e.g., unclear rights-of-way, braking for a pedestrian and increasing the risk of a rear end collision), and so on, may individually or in combination cause the first vehicle 102 to be unsure or otherwise lack sufficient confidence to proceed.

In some examples, when a confidence level or score fails to meet or exceed a threshold confidence level or score, the first vehicle 102 may access or communicate with a computing system or storage device (e.g., local to the vehicle or remotely accessible to the vehicle) to determine if resolution data 112 has already been determined for the uncertainty 106. Doing so may further comprise determining whether previous resolution data remains valid. For example, any given resolution data may remain valid for a corresponding uncertainty or sensor data for a defined time window. In such an example, determining whether to implement resolution data to resolve the uncertainty 106 perceived by the first vehicle 102 may comprise determining whether the first vehicle 102's sensor data is associated with a time (e.g., as logged by log data) that falls within the time window.

As a more concrete nonlimiting example, a vehicle operating in the same environment as the first vehicle 102 may have previously received or determined that navigating the uncertainty 106 as a four-way stop sign was sufficient to successfully resolve the uncertainty 106. The vehicle or an operator may determine or define a time window (e.g., 5 minutes, 30 minutes, 24 hours, 1 week, etc.) for which the resolution data (e.g., treating the uncertainty 106 as a four-way stop sign) remains valid. In other words, after the time window associated with the resolution data expires, the resolution data may no longer be valid or effective, and the techniques discussed herein may re-determine resolution data to avoid stale or ineffective resolution data. In such an example, the first vehicle 102 may, after determining that resolution data associated with the uncertainty 106 exists and prior to implementing or acting on the resolution data, determine whether the resolution data is still valid. The first vehicle may make such a determination based on a duration associated with the resolution data and a time associated with the sensor data which perceived the uncertainty 106.

In other examples, determining whether previously determined or received resolution data is valid may comprise determining whether the first vehicle 102's sensor data associated with the uncertainty is within a defined duration. In examples, the duration may be associated with the uncertainty and its corresponding resolution data. Whereas the time window may be associated with the resolution data and one or more corresponding uncertainties, the duration may be associated with a specific uncertainty in the environment and corresponding resolution data. As a more concrete nonlimiting example, uncertainty 106 may represent a new temporary streetlight put up in a construction zone that was not previously stored in map data (e.g., meaning the first vehicle 102 was not expecting the streetlight and may lack sufficient confidence to navigate it). A vehicle or remote operator may determine that the appropriate resolution data with respect to the streetlight is to navigate it as a standard street light intersection. The streetlight may be associated with the resolution data for a threshold duration (e.g., 1 day, 5 days, 2 weeks). Associating a duration with the streetlight (uncertainty 106) and the corresponding resolution data may reflect an uncertainty about how long the temporary streetlight will remain at the given intersection. The first vehicle 102, prior to implementing or acting on the resolution data stored with respect to the streetlight, may determine whether the time associated with the first vehicle 102's sensor data is prior to expiration of the duration (e.g., since it was first implemented or determined), and thus remains valid.

Additionally or alternatively, when a confidence level fails to meet or exceed a threshold confidence level, the first vehicle 102 may transmit a request for scene confirmation (e.g., confirmation request 108). A confirmation request 108 may be transmitted despite previous resolution data remaining valid (e.g., if, even with the valid resolution data, the vehicle remains unsure or uncertain about the sensor data) or may be transmitted because there is no previous resolution data, or no resolution data that remains valid. The confirmation request 108 may be transmitted to a remote operations system 114, which may comprise one or more remote operators. In examples, the confirmation request 108 may be queued or otherwise held while other confirmation request(s) are received. For more information regarding queuing and responding to received requests for scene confirmations, see U.S. Patent Application Publication Number 2024-0036571 titled, “Teleoperations Queuing for Autonomous Vehicles” which is hereby incorporated by reference in its entirety and for all purposes.

In examples, the remote operations system 114 (e.g., a remote operator) may receive the confirmation request and may determine resolution data 112 appropriate for the confirmation request. Resolution data 112 may comprise any information, context, or action that the remote operator determines is likely to or should resolve the uncertainty 106 and allow the first vehicle 102 to proceed. For example, the resolution data 112 may comprise a suggested action (e.g., nudge forward, merge lanes, proceed forward nominally, adjust acceleration profile (e.g., hard stop), suggest a trajectory modification), an adjustment to sensor data (e.g., clarify that an object is occluded or affected by debris, identify/classify an unknown object or feature), a confirmation of the vehicle's sensor data (e.g., “yes” the light is flashing or “no” the light is not flashing”), a selection of possible responses (e.g., construction flagger is showing a “slow” sign or a “stop” sign, the unknown road sign pertains to a specific animal crossing area), and so on. The resolution data 112 may be transmitted to the first vehicle 102. In at least some examples, the first vehicle 102 may be configured to receive the resolution data 112 and to validate and/or confirm it prior to implementing it. In other words, in some examples, a remote operator or remote operations system 114 may not be capable of directly controlling the first vehicle 102 and may instead only suggest actions or sensor data modifications. Thus, the first vehicle 102 may receive the resolution data 112 and confirm and/or validate that it is both safe and feasible before implementing or acting on it. For information regarding remote operations intervention and guidance, see U.S. Pat. No. 11,768,493, titled, “Remote Vehicle Guidance”, which is hereby incorporated by reference in its entirety and for all purposes. For information regarding vehicle and remote operations collaboration and confirmation, see U.S. Pat. No. 10,606,259, titled “Interactions Between Vehicle and Teleoperations System,” which is hereby incorporated by reference in its entirety and for all purposes.

In some examples, the resolution data 112 may be based at least in part on context data associated with the uncertainty 106. For example, the remote operations system 114 may determine an appropriate suggested action based on map data associated with the uncertainty (e.g., a rural road without intersections may inform what suggested actions are feasible). In another example, a remote operator may gather information and context from sensor data associated with the vehicle and may determine that an obstacle perceived by the vehicle (e.g., which triggered a confirmation request 108) is steam from a manhole or other navigable obstacle. In such an example, the remote operator may determine that the vehicle can safely proceed forward and may suggest a trajectory modification such that the vehicle can validate it and proceed accordingly.

In at least some examples, the first vehicle 102 may transmit an indication that the resolution data 112 successfully resolved the uncertainty 106. For example, the first vehicle 102 may, upon successfully navigating the uncertainty 106, correcting sensor data to meet or exceed a threshold confidence, and so on, transmit an indication that the resolution data 112 was sufficient to resolve the uncertainty 106. In some examples, the indication may comprise annotated resolution data or may comprise additional information, notes, or context associated with the resolution data 112 and how it was used or implemented. For example, if the first vehicle 102 altered or modified a suggested trajectory modification received from a remote operator, the first vehicle 102 may include such alteration or modification in the indication. The additional information or context may be used by the remote operations system 114 to improve the resolution data 112 for other vehicle(s) in the same or similar circumstances.

In some examples, a second vehicle 116 may be navigating an environment 118. In some examples, the second vehicle 116 may be navigating the same or a different environment as that of the first vehicle 102. For example, environment 118 may be the same environment as environment 104. In another example, environment 118 may be a simulated environment or hybrid environment. In another example, environment 118 may be a real-world environment defined by a geofence that is different or separate from a geofence that defines environment 104. In yet another example, environment 118 may be defined by a geofence that overlaps with a geofence that defines environment 104. For purposes of clarity and not limitation, FIG. 1 depicts the first vehicle 102 in a first environment (environment 104) and the second vehicle 116 in a second, different environment (environment 118). One of ordinary skill in the art will understand and appreciate that environment 104 and environment 118 may be any combination of the same real-world environment, a different simulated environment, and so on. The techniques discussed herein are applicable to vehicle(s) in different environments or to vehicle(s) in the same environment.

In some examples, the second vehicle 116 may perceive sensor data about which it lacks the confidence to proceed. In other words, the second vehicle 116 may perceive sensor data that may cause a confidence level associated with a planned trajectory or maneuver to fall below a confidence threshold. As depicted for purposes of clarity and not limitation, the second vehicle 116 may encounter uncertainty 122. Uncertainty 122 may, in some examples, be the same as uncertainty 106. For example, uncertainty 122 perceived by the second vehicle 116 may be the same streetlight that was perceived by the first vehicle 102 and which caused the first vehicle 102 to transmit confirmation request 108. Determining that uncertainty 122 is the same as uncertainty 106 may be based at least in part on context data associated with each uncertainty. For example, a geolocation associated with sensor data that perceived uncertainty 106 may the same as or sufficiently similar to a geolocation associated with sensor data that perceived uncertainty 122, which may indicate that the two uncertainties are the same.

In other examples, uncertainty 122 may be perceived by the second vehicle 116 or associated with sensor data that is different than uncertainty 106. In such examples, the second vehicle 116 or a remote computing system may be configured to recognize similarities between sensor data perceived by different vehicles. For example, the second vehicle 116 and/or a remote computing device may, based at least in part on context data associated with uncertainty 106 and context data associated with uncertainty 122, be configured to recognize that uncertainty 122 is sufficiently similar to uncertainty 106. In such an example, a similarity metric may be associated with the sensor data of uncertainty 106 and the sensor data of uncertainty 122 that meets or exceeds a threshold similarity metric. As a result, the second vehicle 116 and/or the remote computing system may determine that the resolution data 112 that resolved uncertainty 106 is or should be sufficient to resolve uncertainty 122. In other words, based at least in part on a similarity metric between sensor data associated with uncertainty 106 and sensor data associated with uncertainty 122, the resolution data 112 that resolved uncertainty 106 may be reused to address uncertainty 122. Such techniques may be at least partially automated, meaning a computing system may be configured to recognize similarities between different uncertainties or between different scenario data associated with or perceived by different vehicles, to determine similarity metric(s), and/or to proactively transmit appropriate resolution data that may have been successful previously.

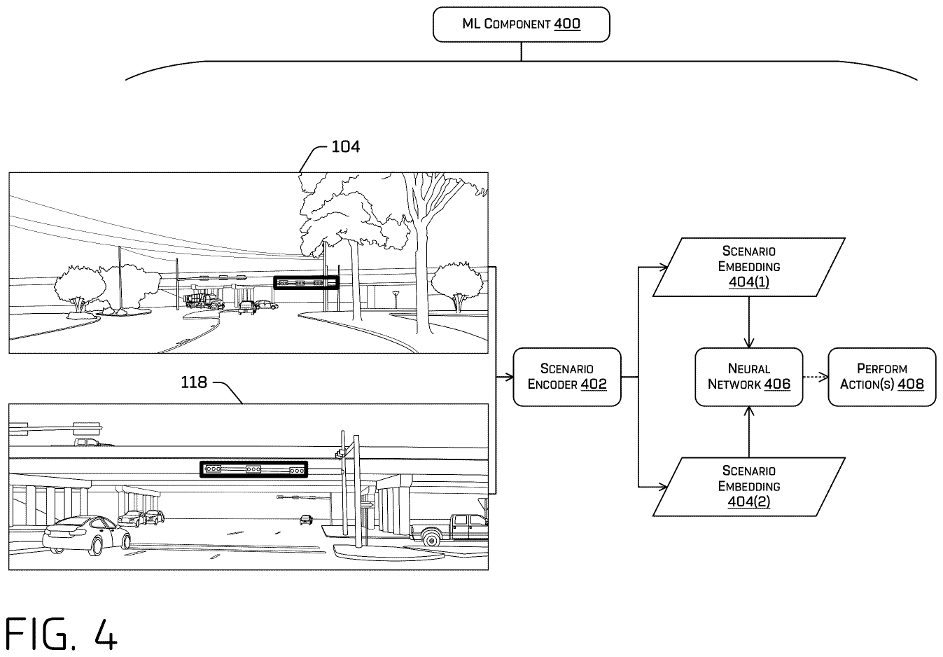

In some examples, a machine-learned (ML) component may be configured to recognize similarities between scenario data perceived by different vehicles (or, e.g., different scenario data perceived by the same vehicle). As discussed in more detail below with regard to FIG. 4, an ML component may comprise a scenario encoder and/or a neural network configured to implement one or more of the techniques discussed herein (e.g., recognize similarities between sensor data). For example, a remote computing resource may receive log data that represents a vehicle scenario and its associated sensor data and may employ a scenario encoder to encode the vehicle scenario(s) and/or sensor data into reduced-dimensionality scenario embeddings. The scenario encoder may be configured to encode (e.g., transform) log data records representing driving scenarios and associated sensor data into reduced-size feature vectors, referred to herein as scenario embeddings. As discussed in more detail below, the scenario encoder may comprise a pretrained foundation model used for general-purpose driving scenario encoding. In some cases, the scenario encoder may comprise a scenario encoder and separate scenario decoder, which may be trained jointly or independently to transform driving scenarios and associated sensor data into scenario embeddings and vice versa. The driving scenario encoder may be implemented and/or trained based on any of the encoder/decoder architectures described herein. The ML component may additionally or alternatively comprise a neural network (e.g., a multi-layer perceptron) that may be associated with the scenario encoder (e.g., built on top of) and be configured to receive as input scenario embedding(s) output by the scenario encoder and/or to determine similarities and differences between the scenario embedding(s) (e.g., compare scenario embedding(s) to determine whether sensor data associated with a first uncertainty perceived by a first vehicle 102 is sufficiently similar to sensor data associated with a second uncertainty perceived by a second vehicle 116).

In some examples, in response to lacking sufficient confidence to proceed, the second vehicle 116 may access a remote computing system or storage device to determine if resolution data sufficient to resolve the problematic sensor data has already been determined (e.g., by another vehicle in the environment). As discussed above with regard to the first vehicle 102, the second vehicle 116 may attempt to retrieve resolution data 120 that may have previously been successful in resolving the same or similar uncertainties. In other examples, a remote computing system may, based at least in part on determining that the second vehicle 116 is or will perceive the same or sufficiently similar sensor data to that perceived by the first vehicle 102, proactively or preemptively transmit the resolution data 112 that was previously successful to the second vehicle 116. In other words, based at least in part on a similarity metric meeting or exceeding a threshold (e.g., uncertainty 122 is the same as or sufficiently similar to uncertainty 106), a remote computing system may transmit the resolution data 112 to the second vehicle 116 such that the second vehicle 116 is better prepared/equipped to navigate uncertainty 122. By doing so, remote operator resources are conserved and the function and reliability of vehicle(s) navigating the environment is improved at least because subsequent vehicles (e.g., second vehicle 116) are better equipped to navigate uncertainties similar to or the same as those encountered by previous vehicles.

In some examples, in response to lacking sufficient confidence about sensor data perceived by the second vehicle 116, the second vehicle 116 may transmit a request for scene confirmation (e.g., confirmation request 124). The second vehicle 116 may do so because of a lack of previous resolution data associated with the uncertainty 122, or because previous resolution data may be invalid (e.g., expired). The second vehicle 116 may transmit confirmation request 124 if, for example, a planned route implicates uncertainty 106 (e.g., the second vehicle 116 is sufficiently confident that it will encounter uncertainty 106 along a planned route).

In at least some examples, rather than the second vehicle 116 transmitting the confirmation request 124, a remote operations system may preemptively or proactively transmit the resolution data 120 to the second vehicle 116 (e.g., because of a similarity between uncertainty 106 and uncertainty 122). In such examples, the second vehicle 116 may not need to transmit confirmation request 124 because, for example, resolution data 112 was successful for resolving uncertainty 106, which may be sufficiently similar to uncertainty 122 (if, e.g., uncertainty 106 and uncertainty 122 are not the same uncertainty but are implicated by similar context data). In another example, resolution data 120 may be retrieved from a remotely accessible computing resource (e.g., a remote computing resource such as a database). In such an example, the second vehicle 116 may proactively retrieve the resolution data 120 from a remote computing resource without transmitting a confirmation request 124. Doing so may reduce the frequency and quantity of confirmation requests and improve the functionality and efficiency of the autonomous vehicle architecture by facilitating autonomous/proactive retrieval of resolution data associated with uncertain sensor data.

In another example, the second vehicle 116 may leverage annotated map data, which may store or flag myriad conditions, features, issues, or other data in association with a map of the environment (e.g., environment 104, environment 118). For example, the second vehicle 116 (or a remote computing resource) may, upon determining a route from a starting location to a destination location, access annotated map data to determine if uncertainties perceived by other vehicles in the environment are along the route. In such an example, the second vehicle 116 may, based on determining that it will or is likely to encounter a known uncertainty, proactively transmit confirmation request 124. Doing so may improve the reliability and functionality of the second vehicle 116 at least because it may receive resolution data 120 prior to encountering uncertainty 122, thereby equipping it with data or information to better navigate or traverse the uncertainty 122.

As discussed above with regard to the first vehicle 102, the second vehicle 116 may additionally or alternatively determine whether resolution data 120 is valid (e.g., has not expired). In at least some examples, the remote computing system may determine whether resolution data 120 is valid, and may only transmit resolution data 120 if indeed it is valid.

In some examples, the second vehicle 116 may, upon correction of sensor data associated with uncertainty 122, navigation of uncertainty 122, or otherwise successful resolution of uncertainty 122, transmit an indication to a remote operations system that resolution data 120 successfully resolved uncertainty 122. Based at least in part on the first vehicle 102 transmitting a first indication of successful resolution of uncertainty 106 and the second vehicle 116 transmitting a second indication of successful resolution of uncertainty 122, map data may be updated such that other vehicles with access to or storing map data have access to resolution data sufficient to resolve the same or similar sensor data in the future. Doing so further improves the function and reliability of vehicles operating in an environment as each vehicle may have access to frequently updated map data that comprises resolution data for myriad uncertainties or sensor data perceptions.

In some examples, if resolution data was not sufficient to resolve the uncertainty for any given vehicle, the vehicle may transmit an indication to that effect, which may be used by a remote computing resource to improve resolution data and/or update previously successful resolution data accordingly. For example, if the first resolution data successfully resolves an uncertainty for a first vehicle but fails to resolve the same or a sufficiently similar uncertainty for a second vehicle, the second vehicle may indicate such. In such an example, the remote computing resource may use that indication and its associated data/information to update the resolution data and/or to update map data such that other vehicles do not receive resolution data that is not sufficiently likely to resolve the same or a similar uncertainty.

In some examples, the first vehicle 102 and/or the second vehicle 116 may wait or refrain from transmitting a confirmation request for a duration. In such an example, a vehicle may perceive an uncertainty or uncertain sensor data and, rather than immediately or automatically transmitting a confirmation request, wait for a duration or distance. For example, the vehicle may wait until it approaches the uncertainty, meaning the vehicle doesn't transmit a confirmation request until it is within a threshold distance from the uncertainty. As a more concrete nonlimiting example, a vehicle may determine that perception data associated with an object one hundred meters forward is uncertain but may refrain from immediately transmitting a confirmation request. In such an example, when the vehicle continues to proceed forward nominally, the perception data of the object at eighty meters, for example, may not be uncertain. That is, proceeding nominally for a duration or distance may provide clarity or allow the vehicle to receive or determine additional contextual data (e.g., sensor data from closer to the object, or out from behind another vehicle) that may be sufficient to resolve the uncertainty without a confirmation request. In another example, refraining from triggering a confirmation request may allow a pedestrian to vacate a roadway or crosswalk, thereby resolving the sensor data without remote operations involvement. Refraining from triggering a confirmation request for a threshold distance or duration may help ensure that the uncertainty or sensor data is indeed uncertain, thereby reducing the quantity and frequency of “false positive” or inappropriate confirmation requests.

In another example, the vehicle may perceive an uncertainty and may continue to operate nominally for an amount of time (e.g., 1, 10, 30 seconds, 10 computing cycles). In such an example, the vehicle may wait or refrain (e.g., institute a time-delay) from transmitting a confirmation request for the duration. There may be myriad reasons for a vehicle to do so. For example, waiting to transmit a confirmation request may ensure that the vehicle is indeed uncertain about the sensor data, and/or may allow for additional processing and analyzation. Doing so may reduce the log of confirmation requests received from a plurality of vehicles in a fleet.

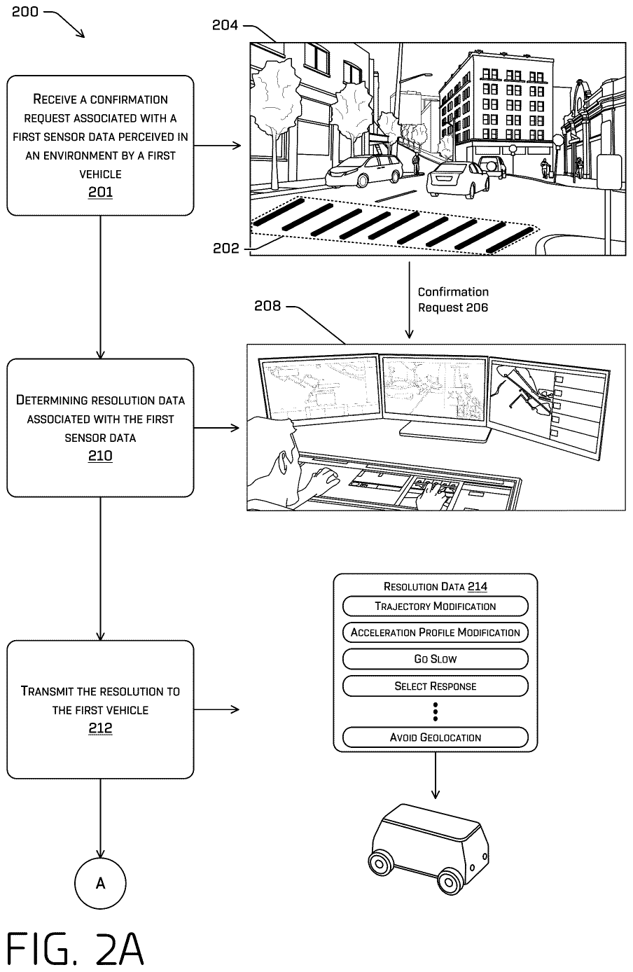

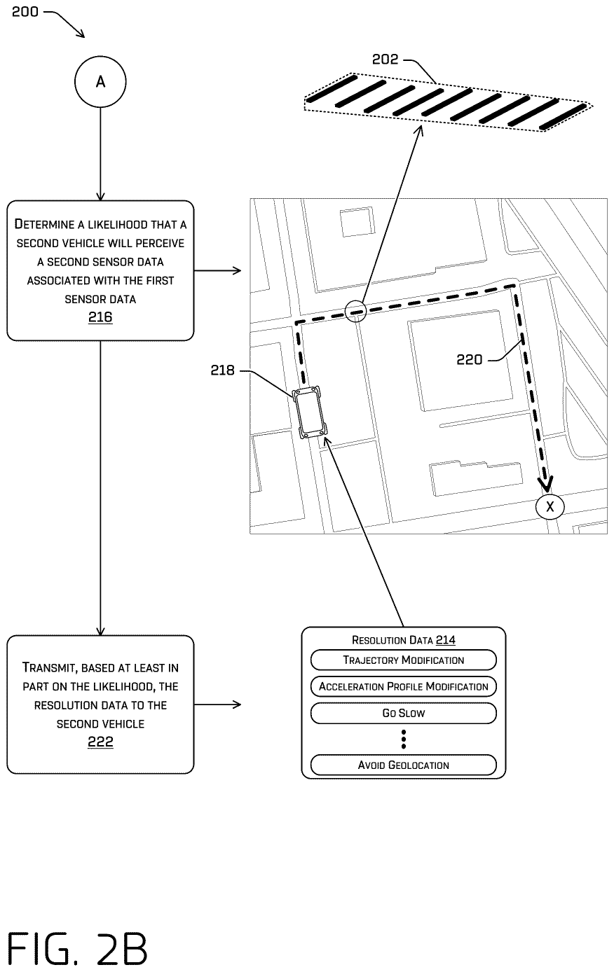

FIGS. 2A and 2B depict an example process 200 configured to implement one or more of the techniques herein. For example, at operation 201, example process 200 may comprise receiving, from a first vehicle, a confirmation request 206 (which may correspond to confirmation request 108 and/or confirmation request 206) associated with a first sensor data 202 perceived in an environment 204. In some examples, the first sensor data 202 may be associated with a specific feature in the environment 204. In other examples, the first sensor data 202 may be more complete and may comprise all real-time log data (and/or e.g., recent log data). As depicted for purposes of clarity and not limitation, the first sensor data 202 is associated with a crosswalk feature. The confirmation request 206 may be transmitted at least in part because the vehicle perceiving the first sensor data 202 is not sufficiently confident to proceed as planned. Such may be the case, for example, if the crosswalk feature was recently added or modified (e.g., painted a different color, crosses at a different angle, etc.). For example, the vehicle may have expected (e.g., based on annotated map data) to proceed through the intersection without stopping or yielding. When the vehicle perceives the crosswalk feature, the vehicle may not be sufficiently confident about how to proceed and may transmit a confirmation request 206.

The confirmation request 206 may be received by a remote operations system 208, which may comprise one or more remote operators. In some examples, the techniques implemented or executed by the remote operations system 208 may be accomplished by a remote operations device or computing system in combination with or in lieu of a remote operator.

At operation 210, example process 200 may comprise determining, based at least in part on the first sensor data 202, resolution data 214 associated with the first sensor data 202. For example, a remote operator in a remote operations system 208 may determine that an acceleration profile modification may be an effective or appropriate action and may indicate such as a suggested action. In another example, the remote operations system 208 may determine that proceeding forward at a reduced speed and treating the crosswalk feature as a regular crosswalk (e.g., stop for pedestrians) is appropriate. In yet another example, the remote operations system 208 may determine that modifying one or more components of the vehicle's sensor data would be likely to resolve any uncertainty associated with the first sensor data 202. As discussed above, in some examples, the vehicle may transmit the confirmation request 206 with predefined options or responses, and the remote operations system 208 may select one of the options or responses that it is sufficiently confident about. For example, the vehicle may transmit a confirmation request 206 that asks, “do the approaching lane markings indicate a crosswalk?” The confirmation request 206 may comprise possible responses, such as “yes,” “no,” and/or “unsure.” In some examples, an “unsure” response will cause the vehicle to traverse according to a set of predefined or default constraints (e.g., below a certain speed, pull over and come to a stop, etc.).

In some examples, the resolution data 214 may comprise an instruction to “go slow” or otherwise constrain operations to maximum thresholds and below. In other examples, a remote operations system 208 may determine that the first sensor data 202 or an uncertainty associated with the first sensor data 202 is not navigable or traversable, or that it is unfeasible or unsafe to do so. In such examples, the remote operations system 208 may instead determine that the appropriate course of action is to avoid a geolocation associated with the first sensor data 202. In other words, the remote operations system 208 may determine that the resolution data 214 most likely to correct the first sensor data 202 (e.g., render the uncertainty moot) is to avoid a geolocation associated with the first sensor data 202 and/or an uncertainty associated with the first sensor data 202.

In some examples, one or more machine-learned (ML) models may be configured to implement one or more of the techniques of operation 210. For example, a large-language model (LLM) and/or vision-language model (VLM) may be trained and configured to receive as input sensor data as captured by one or more sensor(s) associated with a vehicle, and/or to output resolution data. For example, a VLM may be configured to receive as input one or more sensor data (e.g., images, lidar point clouds, etc.) and to analyze the sensor data to determine relevant data and information about the sensor data (e.g., captions, surroundings, bounding boxes, and/or resolution data). In another example, an LLM may be configured to receive as input log data as determined by or associated with sensor data captured by one or more sensor(s) of a vehicle. The LLM may be configured to analyze the log data to determine data and information about the sensor data (e.g., resolution data).

At operation 212, example process 200 may comprise transmitting, to the first vehicle, the resolution data 214. The resolution data 214, as discussed above, may comprise any one or more suggested actions, modifications, and/or contextual information likely to resolve the first sensor data 202. In some examples, the vehicle may, upon receipt of the resolution data 214, confirm or validate its feasibility and/or safety prior to implementing or acting on it.

In some examples, example process 200 may not comprise operation 212. For example, if the first vehicle captures sensor data but cautiously and successfully navigates the first sensor data 202, it may be too late for the first vehicle to receive resolution data at operation 212. In such an example, the first sensor data 202 may remain advantageous for subsequent vehicle(s) which may perceive or encounter the same or similar sensor data, but resolution data transmitted to the first vehicle may not present any benefit (e.g., because the first vehicle has navigated/traversed the first sensor data 202).

Turning now to FIG. 2B, at operation 216, example process 200 may comprise determining, based at least in part on context data associated with a second vehicle 218 operating in the environment 204, a likelihood that the second vehicle will perceive a second sensor data associated with the first sensor data 202. In some examples, the second sensor data may be the same as the first sensor data 202. In other examples, the second sensor data may be sufficiently similar to the first sensor data 202. In other words, based at least in part on context data associated with the first sensor data 202, the second vehicle 218 and/or a remote operations system 208 may determine a likelihood that the second vehicle 218 will perceive an uncertainty that is sufficiently similar to an uncertainty associated with the first sensor data 202. In at least some examples, the likelihood that the second vehicle will perceive a second sensor data associated with the first sensor data 202 may be based at least in part on the likelihood that one or more vehicles will be deployed and/or will traverse a location associated with the first sensor data 202. For example, the likelihood of a second vehicle perceiving second sensor data that is the same as or similar to the first sensor data 202 may be based at least in part on the quantity of vehicle(s) that will or are likely to traverse a given geofence (e.g., a proximity around the first sensor data 202). Such a determination may be estimated or determined based on the quantity of vehicle(s), the likelihood of one or more of those vehicle(s) being within a threshold distance from the first sensor data 202, the demand or number of requests for transportation that are associated with the first sensor data 202 (e.g., how many riders wish to navigate to a destination that comprises a route within a threshold distance of the first sensor data 202), the route taken or expected to be taken by the vehicle that captured the first sensor data 202 and any other vehicles'routes that are similar to that of the route taken by the vehicle that captured the first sensor data 202, and so on.

In some examples, the context data may comprise the characteristics or circumstances associated with the first sensor data 202 (e.g., that gave rise to an uncertainty). For example, the context data may comprise location data, position and orientation data, perception data, trajectory data, map data, and so on. As a more concrete nonlimiting example, a location associated with the first sensor data 202 may be used at least in part to determine a likelihood that the second vehicle 218 will perceive second sensor data that is sufficiently similar to or the same as the first sensor data 202. For example, as depicted by FIG. 2A for purposes of illustration and not limitation, the second vehicle 218 and/or a remote operations system 208 may use a planned route 220 or trajectory and a location associated with the first sensor data 202 to determine whether the planned route implicates (e.g., is sufficiently likely to intersect with) the first sensor data 202. In other words, the planned route 220 of the second vehicle 218 and a location of the first sensor data 202 may be used in part to determine whether the second vehicle 218 may encounter or perceive first sensor data 202.

As an additional nonlimiting example, the position and/or orientation of the perceived crosswalk of the first sensor data 202 may be used to determine a likelihood that the second vehicle 218 will perceive the same or a similar crosswalk. In such an example, the crosswalk of the first sensor data 202 may be compared to other crosswalks in a geofence or along a planned route 220 to determine if the second vehicle 218 is likely to perceive a similarly positioned and/or oriented crosswalk. In other words, the features, characteristics, or circumstances associated with the first sensor data 202 may be used at least in part to determine a likelihood that the second vehicle 218 will perceive second sensor data that is sufficiently similar to the first sensor data 202.

Additionally or alternatively, map data associated with the first sensor data 202 and/or with an uncertainty associated with the first sensor data 202 may be used to determine a likelihood that the second vehicle 218 will perceive second sensor data sufficiently similar to the first sensor data 202. In other words, the second vehicle 218 and/or a remote operations system 208 may use remotely accessible map data to determine which, if any, known or predicted uncertainties may be perceived by the second vehicle 218.

In another example, an uncertainty may be dynamic, and may move around the environment and/or change shape, features, characteristics, etc. For example, the first vehicle may perceive an unusual or abnormal vehicle as it navigates through the environment which may cause the first vehicle to transmit a confirmation request 206. The second vehicle 218 may perceive the unusual or abnormal vehicle in a different location than the first vehicle perceived it. In another example, the first vehicle may perceive a number of traffic cones, which may cause the first vehicle to transmit a confirmation request 206. The second vehicle 218 may perceive a second number of traffic cones in a different location that is similar to the first number of traffic cones. For example, the second vehicle 218 may perceive a different quantity of traffic cones that are in a similar pattern or layout to the first number of traffic cones. In such an example, the second vehicle 218 or a remote operations system may recognize the similarities between the first number of traffic cones and the second number of traffic cones, which may inform the resolution data used to navigate the second number of traffic cones. Notwithstanding the different quantity or other characteristics (e.g., or shape, size, color) of the traffic cones, the second vehicle 218 and/or a remote operations system may be configured to recognize the similar patterns or layouts of the traffic cones and to reuse or apply previously successful resolution data to the second vehicle 218's perception of the second number of traffic cones.

In some examples, a machine-learned (ML) component may be leveraged or implemented to determine whether second sensor data perceived by the second vehicle 218 is sufficiently similar to the first sensor data 202 perceived by the first vehicle 102. As discussed below with regard to FIG. 4, an ML component may be configured to receive as input vehicle scenarios comprising a vehicle and associated sensor data. The ML component may be configured to recognize similarities and/or differences between sensor data perceived by different vehicle(s). The ML component may be executed at predefined intervals or ticks (e.g., 1 second, 10 seconds, 10 computing cycles, at each intersection, etc.) as a vehicle traverses the environment.

In some examples, the ML component may be configured to predict a likelihood that second sensor data perceived by a second vehicle 218 is sufficiently similar to first sensor data 202 perceived by a first vehicle. The ML component may, for example, use map data and previous sensor data associated with given intersections and/or road features along a planned route 220 of a second vehicle 218 to determine similarities between predicted sensor data of the second vehicle 218 and sensor data previously logged or stored. In such an example, resolution data that was previously successful in navigating or resolving an uncertainty may be preemptively transmitted to a second vehicle that is sufficiently likely to perceive a similar uncertainty (e.g., as recognized or determined by an ML component). In other words, for second sensor data perceived by a second vehicle 218 that comprises similar patterns, characteristics, features, etc. compared to first sensor data that was perceived by a first vehicle and was resolved using resolution data, the resolution data may be transmitted to the second vehicle 218 prior to the second vehicle 218 transmitting a request for scene confirmation. For example, the second vehicle 218 may receive the resolution data that was previously successful before the second vehicle transmits a request for scene confirmation, or before a remote operator gets involved.

At operation 222, example process 200 may comprise transmitting, based at least in part on the likelihood, the resolution data 214 to the second vehicle 218. In examples, the second vehicle may be configured to navigate the environment based at least in part on the resolution data 214. For example, the second vehicle 218 may receive the resolution data 214 from the remote operations resource and may validate and/or confirm the feasibility and/or safety of the resolution data 214 before implementing or executing it. In examples, the resolution data 214 may be transmitted when the likelihood that the second vehicle 218 will perceive second sensor data associated with (e.g., sufficiently similar to or the same as) the first sensor data 202 meets or exceeds a threshold likelihood (e.g., 50%, 75%, 95%). The likelihood meeting or exceeding a threshold likelihood may help prevent the transmission of resolution data 214 where it will not be used by the second vehicle 218. In other words, transmitting the resolution data 214 to the second vehicle 218 when the likelihood meets or exceeds a threshold likelihood may help prevent unnecessary or convoluted data being transmitted the second vehicle 218 where it is not sufficiently likely that the second vehicle 218 will perceive the same or a similar uncertainty.

In at least some examples, the first sensor data 202 perceived or captured by the first vehicle may be uncertain or unclear, which may cause the first vehicle to transmit a confirmation request 206. As a more concrete nonlimiting example, the first vehicle may perceive a road sign that is blurry or otherwise unreadable by the first vehicles'sensor(s) (e.g., or the vehicle is not sufficiently confident about what the road sign says). In another example, a temporary road sign (e.g., in a construction zone) may be unexpected (e.g., not stored in map data that the first vehicle uses to navigate a trajectory). As discussed above, one possible resolution data is to avoid the geolocation associated with the blurry or temporary road sign. In another example, resolution data that determines what the road sign says, why it is there, and what it directs vehicle(s) to do may allow second and subsequent vehicle(s) to continue navigating the environment associated with the blurry or temporary road sign. As a more concrete nonlimiting example, a road sign may read, “no left turn,” in large font and “between 7:00 am and 5:00 pm M-F” in smaller font. A first vehicle perceiving such a road sign may perceive and interpret what “no left turn” directs or requires, but the first vehicle may not be sufficiently confident about the second clause written on the sign (e.g., “between 7:00 am and 5:00 pm M-F”) (e.g., because the text is blurry or partially occluded, because the font is too small, etc.). The first vehicle may transmit a confirmation request 206 accordingly. A machine-learned (ML) model, remote operator, or otherwise may receive the request and may have tools or resources to determine what the full text of the sign states (e.g., they may “rewind” the sensor data and/or zoom in or enlarge the text of the sign). Doing so may allow the ML model, the remote operator, or otherwise to determine appropriate resolution data. For example, the resolution data may comprise updating map data with the proper label and instructions (e.g., so that second and subsequent vehicles expect the road sign and understand its directions). In another example, the resolution data may comprise preemptively or proactively transmitting the image, label(s), and/or other data (e.g., what the sign directs/requires of vehicles) to other vehicle(s). For example, the resolution data may be transmitted to all other vehicles within a given proximity (or, e.g., to vehicle(s) associated with a route that may implicate or include the given proximity) of the blurry or temporary road sign (e.g., within a geofence), to other vehicle(s) that are likely to navigate within a threshold distance of the blurry or temporary road sign, to other vehicle(s) that may be assigned to, or otherwise navigate a geographic region within or during a defined time range, and/or any combination thereof.

In another example, the resolution data may be transmitted to the second and subsequent vehicle(s) based on one or more of vehicle attributes or characteristics associated with the second and subsequent vehicle(s). For example, in keeping with the blurry or temporary road sign example from above, the appropriate resolution data may be proactively or preemptively transmitted to second and subsequent vehicle(s) which have a specific model of camera or LIDAR sensor (e.g., an older version which may not have as powerful of zoom capabilities).

In some examples, prior to transmitting the resolution data 214 to the first vehicle and/or to the second vehicle 218, the techniques discussed herein may determine whether the resolution data 214 is valid. For example, the resolution data 214 may be transmitted to the second vehicle 218 only if a time associated with the second sensor data and a time associated with the first sensor data are within a predefined time window (e.g., 1 hour). In such an example, the resolution data 214 may be valid for the first sensor data 202 and sufficiently similar second sensor data for a defined time window. In another example, prior to transmitting the resolution data 214 to the second vehicle 218, the techniques herein may determine whether a time associated with the second sensor data is within a defined duration associated with the uncertainty. In other words, an uncertainty associated with the first sensor data 202 may remain valid only for a given duration (e.g., 24 hours, 1 week), and determining whether the resolution data 214 is valid for use by the second vehicle 218 may comprise determining whether a time associated with the second sensor data is within the duration.

Transmitting the resolution data 214 to the second vehicle 218 may occur before the second vehicle 218 perceives second sensor data sufficiently similar to the first sensor data 202. In other words, the resolution data 214 may be transmitted to the second vehicle 218 before it is likely to perceive the uncertainty such that the second vehicle 218 is better prepared to perceive the uncertainty and to navigate the environment with minimal or no disruption. For example, the resolution data 214 may be transmitted to the second vehicle 218 before the second vehicle embarks on the planned route 220 so that it is aware of possible uncertainties and can traverse them without transmitting a request for scene confirmation.

In some examples, as discussed in more detail above, the second vehicle 218 may transmit an indication that the resolution data 214 successfully resolved the second sensor data. In other examples, the second vehicle 218 may transmit an indication that the resolution data 214 was insufficient or failed to resolve the second sensor data. In such an example, the remote operations system 208 may receive the indication and update the resolution data 214 accordingly. In some examples, the remote operations system 208 may update map data associated with the first sensor data 202, the second sensor data, and/or an uncertainty associated with either.

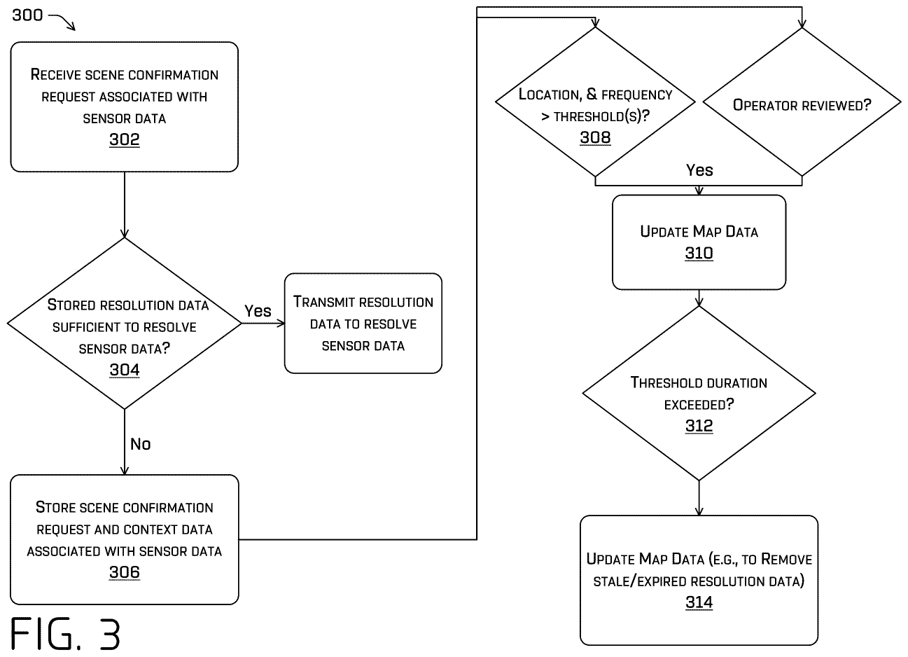

FIG. 3 depicts an example framework 300 configured to implement one or more of the techniques discussed herein. Example framework 300 may be implemented by a remote operations system (e.g., remote operations system 208), which may monitor and/or manage one or more vehicles (e.g., a fleet) operating in an environment. At operation 302, example framework 300 may comprise receiving a scene confirmation request associated with sensor data received from a first vehicle operating in the environment. At operation 304, example framework 300 may determine whether previous resolution data (e.g., resolution data 214) is sufficient to resolve the sensor data. For example, a remote operations system may maintain a storage device or service (e.g., annotated map data stored on a remotely accessible server) which may be communicatively coupled to the one or more vehicles. For example, previously used and/or previously successful resolution data may be stored in association with the uncertainties or sensor data that each resolution data resolved. One or more vehicle(s) in an environment may have access to or may be communicatively coupled to a remote operations system that has access to the storage device or service that houses previous resolution data and associated sensor data. For example, the first vehicle 102 and/or the second vehicle 116 may access a storage device or service discussed with regard to FIG. 3.

In some examples, if stored resolution data is sufficient to resolve the sensor data perceived by the vehicle, the resolution data may be transmitted or retrieved by the vehicle, verified/validated, and implemented accordingly. In some examples, determining whether the stored resolution data is sufficient to resolve the sensor data may comprise determining whether a confidence level associated with the resolution data meets or exceeds a threshold confidence level.

If there is no stored resolution data sufficient to resolve the sensor data (e.g., there is no applicable resolution data from the same or similar sensor data and/or a confidence level that stored resolution data will resolve the sensor data fails to meet or exceed a threshold confidence level), example framework 300 may follow the “no” block and proceed to operation 306.

At operation 306, example framework 300 may comprise storing the scene confirmation request and context data associated with the vehicle that transmitted the request (e.g., location, position, orientation, perception data, road feature classification, etc.). In other words, the confirmation request may be stored in association with context data associated with the vehicle that transmitted the confirmation request. At operation 308, example framework 300 may comprise analyzing the request for scene confirmation in greater depth. For example, operation 308 may comprise determining whether the request for scene confirmation has been received a threshold number of times and/or whether the request for scene confirmation has been received from more than one vehicle operating in the same location. For example, operation 306 may comprise determining whether the request for scene confirmation has been received more than one time in association with more than one vehicle. Doing so may help prevent false positives where an individual vehicle erroneously transmits a request for scene confirmation (e.g., out of an abundance of caution, because of faulty sensor data, etc.) where the sensor data is unique to the vehicle and may not be sufficiently likely to be perceived by another vehicle. For example, a remote operations system may, prior to storing or logging the request for scene confirmation and associated resolution data, wait until the sensor data is perceived by multiple vehicle(s) or by the same vehicle multiple times. Doing so prevents the storage of unusable or otherwise unique requests for scene confirmation and associated resolution data which may not feasibly or practically be reused for other similar sensor data.

Additionally or alternatively, at operation 308, example framework 300 may comprise determining whether a vehicle has already navigated through an area associated with a confirmation request. In such an example, if a vehicle has navigated through a location that previously caused vehicle(s) to transmit confirmation request(s) did not similarly transmit a confirmation request, it may indicate that the uncertainty or sensor data no longer exists (or, e.g., has been modified such that vehicle(s) no longer need resolution data to navigate it). For example, if a subsequent vehicle navigates through an intersection that has previously caused confirmation requests by other vehicles, the lack of confirmation request transmitted by the subsequent vehicle may indicate that the uncertainty has been modified or resolved. In such an example, map data may be updated to remove the resolution data associated with the uncertainty that has been sufficiently resolved. In some such examples, the scenarios may be analyzed by an operator to determine why the uncertainty is no longer causing vehicle(s) to transmit confirmation request(s), and whether further action should be taken (e.g., cause other vehicles to avoid the location, update map data, and so on). Reviewing such scenarios may improve the overall system by ensuring that the subsequent vehicle(s) are not missing the uncertainty or sensor data by mistake or because of a faulty component.

Additionally or alternatively, determining whether to store the request for scene confirmation may be based at least in part on whether a remote operator has reviewed the request and its associated context data/circumstances. For example, the request for scene confirmation may be reviewed by a remote operator to determine whether the context data and/or resolution data may be sufficiently likely to be experienced by another vehicle. For example, a remote operator may determine whether the request for scene confirmation is associated with sensor data and/or context data which may be reasonably likely to occur again (e.g., perceived by the same vehicle another time or perceived by different vehicle(s)). Doing so may further reduce the likelihood and/or frequency of false positive requests for scene confirmation. For example, a storage device or service as discussed may be more efficient and less prone to mistakes or faulty data.

In some examples, if the request for scene confirmation has occurred more than one time, has been received in association with the same or a similar location more than one time, and/or has been reviewed by a remote operator, example framework may follow the “yes” block and proceed to operation 310. For example, at operation 310, example process may comprise updating map data with the request and its associated context data and/or resolution data. Updating map data may comprise “publishing” or otherwise linking resolution data with the sensor data associated with any given request such that other vehicle(s) in the fleet can remotely access the map data and be better prepared/equipped to navigate the environment. For example, a second vehicle in the environment may access map data associated with a planned route (e.g., planned route 220), and determine that one or more requests have been transmitted in one or more locations along the planned route.

In some examples, at operation 312, example framework 300 may comprise determining whether a threshold duration has been exceeded. To prevent expired or unused resolution data, a defined duration may be used to determine whether the request for scene confirmation and/or its associated resolution data has become stale or is otherwise invalid. For example, if a threshold duration has passed since a request was received in association with a sensor data, example framework 300 may follow the “yes” block and proceed to operation 314.

At operation 314, example framework 300 may update map data to reflect that the sensor data associated with the request for scene confirmation is no longer uncertain (e.g., the sensor data has successfully been resolved and no more requests for scene confirmation are received in association with the sensor data). In such examples, the request(s) may be removed from the remote storage device or service. In at least some examples, prior to updating the map data, the resolution data may be reviewed by an operator. That is, a remote operator may review resolution data associated with an uncertainty to determine if map data should be updated to remove the stored resolution data. In some such examples, an operator may determine that the resolution data should remain in map data (e.g., indefinitely, or for a determined duration (e.g., one day, one week, etc.)), and may save or store the resolution data accordingly (e.g., instead of removing it automatically because it has expired).

FIG. 4 depicts an example ML framework configured to implement one or more of the techniques discussed herein. For example, the example ML framework may be configured to recognize or determine similarities between sensor data perceived by two or more vehicles. As depicted, the example ML framework may comprise ML component 400, which may be an example representation of ML component 702 discussed in more detail below. ML component 400 may be multi-layer architecture including one or more scenario encoder(s) (e.g., scenario encoder 402) and a neural network 406. In at least some examples, ML component 400 may comprise a single neural network. In other words, rather than being a multi-layer architecture, ML component 400 may comprise a single neural network trained and configured to receive vehicle sensor data.

As depicted, a scenario encoder 402 may be configured to receive as input a vehicle sensor data associated with (e.g., logged by) a vehicle (which may correspond to first vehicle 102 and/or second vehicle 218) traversing an environment (e.g., environment 104, environment 118). As discussed above, log data logged by a vehicle (e.g., from a real-world, simulated, or hybrid environment) may be encoded by a scenario encoder 402 configured to output a scenario embedding(s) (e.g., scenario embedding 404(1), scenario embedding 404(2)). The scenario encoder 402 may be configured and/or trained to encode the log data (e.g., sensor data) into reduced-size scenario embeddings comprising feature vectors. The scenario encoder 402 may encode the various log data (e.g., ego vehicle data, static object data, agent state data, map feature data, object detection data, traffic signal data, perception data, etc.) at any number of time steps over the duration of a vehicle scenario (e.g., a 5-second, 10-second, or 30-second vehicle scenario, etc.). Although encoding the simulation log data into a reduced-sized scenario embedding (e.g., scenario embedding 404(1), scenario embedding 404(2)) may remove or obscure certain data from the log data (e.g., precise object/agent states at every timestep), the scenario encoder 402 may be trained to retain the high-level characteristics and various relevant attributes of the log data within the scenario embedding(s). For a more complete discussion of scenario encoder 402 and associated components, see at least U.S. patent application Ser. No. 18/620,616, entitled “Estimating Driving Behavior Metrics Using Scenario Embeddings,” filed on Aug. 30, 2024, which is hereby incorporated by reference in its entirety and for all purposes.

In some examples, various elements (objects, features, agents, etc.) in the sensor data may have separate vectors (e.g., with predetermined vector sizes and predetermined positions in the scenario embedding(s)) to represent agent embeddings, feature embeddings, map feature embeddings, and the like. For example, the agent embeddings may include the set of state vectors representing the agents within the sensor data, including the ego vehicle (or a simulated vehicle in a simulation). The agent embeddings may encode various agent attributes, for example, agent positions, sizes, classifications, orientations, velocities, accelerations, and the like. Similarly, map feature embeddings may encode various attributes of the map data and/or the static objects, and the traffic signal embeddings may encode the attributes of the map features (e.g., traffic light states, temporary lane permissibility, stop signs, crosswalk usage, forced merge distances).

Elements (e.g., objects, agents, features) of the sensor data may be structured with specific embeddings/vector sets at predetermined sizes and locations. In some cases, a predetermined size and/or structure of the elements (e.g., having agent embeddings, map feature embeddings, traffic signal embeddings, and the like at predetermined locations and sizes within the embeddings) may be based on the size and structure of the log data associated with the sensor data. Additionally or alternatively, the scenario encoder 402 may receive sensor data having various different sizes and/or structures.

In at least some examples, a neural network 406 (e.g., a multi-layer perceptron, a head of the scenario encoder 402, or other suitable neural network as discussed below) may be associated with the scenario encoder 402. The neural network 406 may be configured to receive as input the scenario embedding(s) and to output, based at least in part on the scenario embedding(s), myriad similarities and/or differences between the scenario embedding(s). Additionally or alternatively, the neural network 406 may be configured to determine a similarity metric or level associated with two or more input scenario embedding(s), which may be used at least in part to determine whether second sensor data perceived by a second vehicle is sufficiently similar to first sensor data perceived by a first vehicle, as discussed above.

Additionally, in some examples, neural network 406 may be trained and configured to recognize characteristics between multiple scenario embeddings and to determine similarities/differences between them. By doing so, neural network 406 may recognize sensor data perceived by multiple vehicles with similar circumstances/elements and cluster those together for additional analysis. In other words, neural network 406 may be configured to group together similarly problematic or uncertain driving scenarios or circumstances such that valuable information can be identified/extracted from a plurality of driving scenarios and/or circumstances.

In some examples, neural network 406 may be trained at least in part by ground truth data associated with vehicle(s) operating in an environment. For example, ground truth sensor data may be encoded (e.g., via scenario encoder 402 or a similar component) to generate ground truth scenario embeddings and/or labeled (e.g., with characteristics of the sensor data). The ground truth scenario embeddings may be used to train the neural network 406 to determine similarities between multiple perceived uncertainties. In other examples, neural network 406 may be trained based at least in part on a plurality of sensor data perceived by multiple vehicles, where individual sensor data are associated with a vehicle traversing an environment. Individual sensor data may each be encoded (e.g., by scenario encoder 402) into scenario embeddings. Neural network 406 may determine similarities between the scenario embedding(s). For example, the neural network 406 may determine, based on the scenario embedding(s), various characteristic(s) associated with each uncertainty, and may apply a positive label (e.g., feedback) to the associated scenario embeddings. Additionally or alternatively, the neural network 406 may apply a negative label/filter to sensor data that are sufficiently dissimilar.

In some examples, ML component 400 may additionally or alternatively cause one or more actions to be performed. For example, if the neural network 406 determines a similarity between two scenario embeddings that meets or exceeds a threshold similarity, resolution data that successfully resolved an uncertainty in environment 104 may be transmitted to a vehicle that is sufficiently likely to encounter the similar uncertainty in environment 118. In other examples, operation 408 may comprise updating map data, as discussed in more detail above.

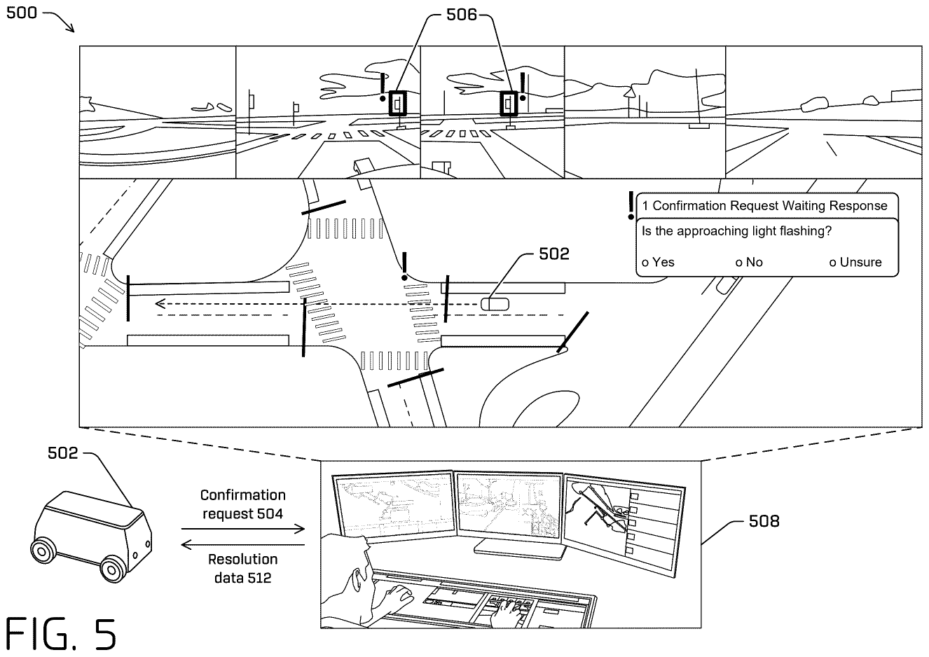

FIG. 5 depicts an example environment 500 configured to implement one or more of the techniques discussed herein. As depicted for purposes of clarity and not limitation, example environment 500 may comprise a vehicle 502 (which may correspond to the first vehicle 102, second vehicle 116, etc.) navigating an environment. In some examples, the vehicle 502 may perceive sensor data 506 associated with an uncertainty in the environment which causes the vehicle to lack sufficient confidence about how to proceed. For example, the sensor data 506 may comprise an unclassified object, an unexpected road feature, an unpredictable obstacle or pedestrian, and so on. As discussed above, the sensor data 506 may be any object, agent, pedestrian, occlusion, or otherwise which causes the vehicle 502 to be less than sufficiently confident about proceeding nominally. In response to the vehicle 502 failing to be sufficiently confident about sensor data 506, the vehicle 502 may transmit a request for scene confirmation (e.g., confirmation request 504) to a remote operations system 508 (which may correspond to remote operations system 208).

As discussed above, the confirmation request 504 may be associated with one or more possible responses. For example, as depicted for purposes of clarity and not limitation, the confirmation request 504 may present possible responses to the question “is the approaching light flashing?” such as “Yes,” “No,” and/or “Unsure.” In other examples, the confirmation request 504 may be open-ended and may allow the remote operations system 508 to input text data, suggested action data, modified sensor data, and so on. One of ordinary skill in the art will understand and appreciate the myriad characteristics and/or formats that a confirmation request 504 may comprise.

The remote operations system 508 may be configured to select one of the presented responses based at least in part on the contextual data associated with the sensor data 506. As depicted, the remote operations system 508 may get up to speed or become familiar with the sensor data using perception data and/or map data associated with the vehicle 502. Based on the context data, the remote operations system 508 may determine resolution data 512 likely or configured to resolve the sensor data 506 associated with the confirmation request 504. The remote operations system 508 may transmit the resolution data 512 to the vehicle 502 to resolve the sensor data 506.

In some examples, as discussed above, the techniques herein may be configured to recognize similar sensor data perceived by different vehicles and to preemptively or proactively transmit the resolution data that was previously successful. For example a second vehicle operating in the same environment as vehicle 502. The remote operations system 508 and/or the second vehicle may determine a likelihood that the second vehicle will perceive second sensor data that is associated with sensor data 506 (e.g., the same sensor data or sufficiently similar sensor data). If the likelihood meets or exceeds a threshold likelihood, the resolution data 512 may be transmitted to the second vehicle prior to the second vehicle perceiving the second sensor data. Doing so may improve the functionality and reliability of the second vehicle at least in part because it is equipped with resolution data 512 to resolve the second sensor data and traverse the environment with minimal or no disruption (and, e.g., without transmitting a request for scene confirmation).

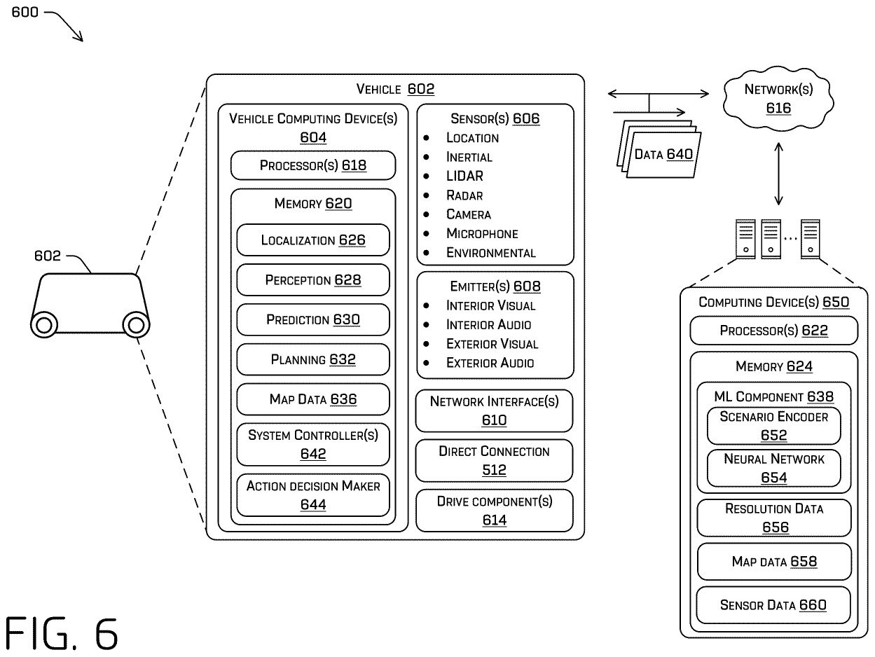

FIG. 6 illustrates a block diagram of an example system 600 for implementing the techniques discussed herein. The vehicle 602 (which may be first vehicle 102, second vehicle 218, and/or vehicle 502) may include one or more vehicle computing device(s) 604, one or more sensor system(s) 606, one or more emitters 608, one or more network interface(s) 610, at least one direct connection (e.g., one or more of a direct connection 612), and one or more drive component(s) 614.

Vehicle computing device(s) 604 may include one or more processor(s) 618 and memory 620 communicatively coupled with the one or more processor(s) 618. In examples, memory 620 (and/or memory 624) may store processor-executable instructions that, when executed, cause the one or more processor(s) 618 (and/or processor(s) 622) to implement one or more of the techniques, processes, and/or methods herein. In the example system 600, the vehicle 602 is an autonomous vehicle; however, the vehicle 602 could be any other type of vehicle or mobile robot. In the example system 600, the memory 620 of the vehicle computing device(s) 604 stores a localization component 626, a perception component 628, a prediction component 630, a planning component 632, map data 636, one or more system controller(s) 642, and an action decision maker 644. Though depicted in FIG. 6 as residing in memory 620 for illustrative purposes, it is contemplated that the localization component 626, the perception component 628, the map data 636, the one or more system controller(s) 642, the prediction component 630, the action decision maker 644, and/or the planning component 632 may additionally, or alternatively, be accessible to the vehicle 602 (e.g., stored remotely). Although depicted in FIG. 6 as being a component of vehicle 602, action decision maker 644 may be a component of computing device(s) 650. Action decision maker 644 may be at least in part responsible for validating, verifying, and/or confirming appropriate action(s) to implement or implement based on resolution data.

In at least one example, the localization component 626 may include functionality to receive data from the sensor system(s) 606 to determine a position and/or orientation of the vehicle 602 (e.g., one or more of an x-, y-, z-position, roll, pitch, or yaw). For example, the localization component 626 may include and/or request/receive a map of an environment and may continuously determine a location and/or orientation of the autonomous vehicle within the map. In some instances, the localization component 626 may utilize SLAM (simultaneous localization and mapping), CLAMS (calibration, localization and mapping, simultaneously), relative SLAM, bundle adjustment, non-linear least squares optimization, or the like to receive image data, lidar data, radar data, IMU data, GPS data, wheel encoder data, and the like to accurately determine a location of the autonomous vehicle. In some instances, the localization component 626 may provide data to various components of the vehicle 602 to determine an initial position of an autonomous vehicle for generating a trajectory and/or for generating or receiving map data, as discussed herein.

In some instances, the perception component 628 may include functionality to perform object detection, segmentation, and/or classification. In some examples, the perception component 628 may provide processed sensor data that indicates a presence of an entity that is proximate to the vehicle 602 and/or a classification of the entity as an entity type (e.g., car, pedestrian, cyclist, animal, building, tree, road surface, curb, sidewalk, unknown, etc.). In additional or alternative examples, the perception component 628 may provide processed sensor data that indicates one or more characteristics associated with a detected entity (e.g., a tracked object) and/or the environment in which the entity is positioned. In some examples, characteristics associated with an entity may include, but are not limited to, an x-position (global and/or local position), a y-position (global and/or local position), a z-position (global and/or local position), an orientation (e.g., a roll, pitch, yaw), an entity type (e.g., a classification), a velocity of the entity, an acceleration of the entity, an extent of the entity (size), etc. Characteristics associated with the environment may include, but are not limited to, a presence of another entity in the environment (e.g., an agent), a state of another entity (e.g., an object or feature) in the environment, a time of day, a day of a week, a season, a weather condition, an indication of darkness/light, etc.

The memory 620 may further include map data 636 that may be used by the vehicle 602 to navigate and/or traverse within the environment. For the purpose of this discussion, map data may comprise any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: texture information (e.g., color information (e.g., RGB color information, Lab color information, HSV/HSL color information), and the like), intensity information (e.g., LIDAR information, RADAR information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, map data 636 may include a three-dimensional mesh of the environment. In some instances, map data 636 may be stored in a tiled format, such that individual tiles of the map represent a discrete portion of an environment, and may be loaded into working memory as needed, as discussed herein. In at least one example, the map data 636 may include at least one map (e.g., images and/or a mesh). In some examples, the vehicle 602 may be controlled based at least in part on the map data 636. In some examples, map data 636 may be stored on a remote computing device(s) (such as the computing device(s) 650) accessible via network(s) 616. In some examples, multiple maps may be stored based on, for example, a characteristic (e.g., type of entity, time of day, day of week, season of the year, etc.). Storing multiple maps may have similar memory requirements but increase the speed at which data in a map may be accessed.

In at least one example, the vehicle 602 may include one or more system controller(s) 642, which may be configured to control steering, propulsion, braking, safety, emitters, communication, and other systems of the vehicle 602. These system controller(s) 642 may communicate with and/or control corresponding systems of the drive component(s) 614 and/or other components of the vehicle 602.

In some examples, the prediction component 630 may include functionality to generate one or more probability maps representing prediction probabilities of possible locations of one or more objects or agents in an environment. For example, the prediction component 630 can generate one or more probability maps for vehicles, pedestrians, animals, and the like within a threshold distance from the vehicle 602. In some instances, the prediction component 630 can measure a track or trajectory of an object/agent and generate a discretized prediction probability map, a heat map, a probability distribution, a discretized probability distribution, and/or a trajectory for the object/agent based on observed and predicted behavior. In some instances, the one or more probability maps can represent an intent of the one or more objects/agents in the environment.

In some examples, the planning component 632 may include functionality to determine a path for the vehicle 602 to follow to traverse through an environment (e.g., a trajectory as depicted by a dashed line in FIGS. 1, 2A and 4). For example, the planning component 632 can determine various routes and paths and various levels of detail. In some instances, the planning component 632 can determine a route to travel from a first location (e.g., a current location) to a second location (e.g., a target location). For the purpose of this discussion, a route can be a sequence of waypoints for traveling between two locations. As non-limiting examples, waypoints include streets, intersections, global positioning system (GPS) coordinates, etc. Further, the planning component 632 can generate an instruction for guiding the autonomous vehicle along at least a portion of the route from the first location to the second location. In at least one example, the planning component 632 can determine how to guide the autonomous vehicle from a first waypoint in the sequence of waypoints to a second waypoint in the sequence of waypoints. In some examples, the instruction can be a path, or a portion of a path. In some examples, multiple paths can be substantially simultaneously generated (i.e., within technical tolerances) in accordance with a receding horizon technique. A single path of the multiple paths in a receding data horizon having the highest confidence level may be chosen to operate the vehicle.

In other examples, the planning component 632 can alternatively, or additionally, use data from the perception component 628 and/or the prediction component 630 to determine a path for the vehicle 602 to follow to traverse through an environment. For example, the planning component 632 can receive data from the perception component 628 and/or the prediction component 630 regarding objects/agents/features associated with an environment. Using this data, the planning component 632 can determine a route to travel from a first location (e.g., a current location) to a second location (e.g., a target or destination location) to avoid objects in an environment. In at least some examples, such a planning component 632 may determine there is no such collision free path and, in turn, provide a path which brings vehicle 602 to a safe stop avoiding all collisions and/or otherwise mitigating damage.

In some examples, example system 600 may additionally or alternatively comprise an error monitoring component. The error monitoring component may be responsible for or tasked with monitoring the systems and components of the vehicle 602 (e.g., sensor system(s) 606, drive component(s) 614, etc.) and to log, report, or otherwise flag errors experienced by the vehicle 602 and/or its systems and components. The error monitoring component may determine if and when errors (e.g., vehicle errors states) occur, and/or may classify errors based on their severity/importance to the overall functionality of the vehicle 602 system.

In some instances, aspects of some or all of the components discussed herein may include any models, algorithms, and/or machine learning algorithms. For example, in some instances, the components in the memory 620 (and the memory 624, discussed below) may be implemented as a neural network. For example, as discussed above, the remote computing device(s) 650 may leverage or employ one or more neural networks in carrying out the techniques described herein.

As described above, an exemplary neural network is an algorithm which passes input data through a series of connected layers to produce an output. Each layer in a neural network may also comprise another neural network or may comprise any number of layers (whether convolutional or not). As may be understood in the context of this disclosure, a neural network may utilize machine learning, which may refer to a broad class of such algorithms in which an output is generated based on learned parameters.

Although discussed in the context of neural networks, any type of machine learning may be used consistent with this disclosure. For example, machine learning algorithms and/or techniques discussed below with regard to FIG. 5 may be leveraged individually or in combination to accomplish the techniques herein.

In at least one example, the sensor system(s) 606 may include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, etc.), time of flight sensors, audio sensors, wheel encoders, environment sensors (e.g., temperature sensors, humidity sensors, light sensors, pressure sensors, etc.), etc. The sensor system(s) 606 may include multiple instances of each of these or other types of sensors. For instance, the lidar sensors may include individual lidar sensors located at the corners, front, back, sides, and/or top of the vehicle 602. As another example, the camera sensors may include multiple cameras disposed at various locations about the exterior and/or interior of the vehicle 602. The sensor system(s) 606 may provide input to the vehicle computing device(s) 650. Additionally, or alternatively, the sensor system(s) 606 may send sensor data, via the one or more network(s) 616, to the one or more computing device(s) at a particular frequency, after a lapse of a predetermined period of time, in near real-time, etc. In at least some examples, the sensor system(s) 606 may be responsible for determining sensor data as discussed above.

The vehicle 602 may also include one or more emitters 608 for emitting light and/or sound, as described above. The emitters 608 in this example include interior audio and visual emitters to communicate with passengers of the vehicle 602. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The emitters 608 in this example also include exterior emitters. By way of example and not limitation, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 602 may also include one or more network interface(s) 610 that enable communication between the vehicle 602 and one or more other local or remote computing device(s). For instance, the network interface(s) 610 may facilitate communication with other local computing device(s) on the vehicle 602 and/or the drive component(s) 614. Also, the network interface(s) 610 may allow the vehicle 602 to communicate with other nearby computing device(s) (e.g., other nearby vehicles, traffic signals, etc.). The network interface(s) 610 may also enable the vehicle 602 to communicate with remote operations (e.g., with remote operations and/or with communication component 242) or other remote services.

The network interface(s) 610 may include physical and/or logical interfaces for connecting the vehicle computing device(s) 650 to another computing device (e.g., a vehicle 602) or a network, such as network(s) 616. For example, the network interface(s) 610 may enable Wi-Fi-based communication such as via frequencies defined by the IEEE 602.11 standards, short range wireless frequencies such as Bluetooth, cellular communication (e.g., 2G, 3G, 4G, 4G LTE, 5G, etc.) or any suitable wired or wireless communications protocol that enables the respective computing device to interface with the other computing device(s).

In at least one example, the vehicle 602 may include one or more drive component(s) 614. In some examples, the vehicle 602 may have a single drive component. In at least one example, if the vehicle 602 has multiple drive component(s) 614, individual drive components may be positioned on opposite ends of the vehicle 602 (e.g., the front and the rear, etc.). In at least one example, the drive component(s) 614 may include one or more sensor systems to detect conditions of the drive component(s) 614 and/or the surroundings of the vehicle 602 (e.g., monitored by an error monitoring component). By way of example and not limitation, the sensor system(s) may include one or more wheel encoders (e.g., rotary encoders) to sense rotation of the wheels of the drive systems, inertial sensors (e.g., inertial measurement units, accelerometers, gyroscopes, magnetometers, etc.) to measure orientation and acceleration of the drive system, cameras or other image sensors, ultrasonic sensors to acoustically detect objects in the surroundings of the drive system, lidar sensors, radar sensors, etc. Some sensors, such as the wheel encoders may be unique to the drive component(s) 614. In some cases, the sensor system(s) on the drive component(s) 614 may overlap or supplement corresponding systems of the vehicle 602 (e.g., sensor system(s) 606).

The drive component(s) 614 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 614 may include a drive system controller which may receive and preprocess data from the sensor system(s) and to control operation of the various vehicle systems. In some examples, the drive system controller may include one or more processors and memory communicatively coupled with the one or more processors. The memory may store one or more components to perform various functionalities of the drive component(s) 614. Furthermore, the drive component(s) 614 also include one or more communication connection(s) that enable communication by the respective drive system with one or more other local or remote computing device(s).

In at least one example, the direct connection 612 may provide a physical interface to couple the one or more drive component(s) 614 with the body of the vehicle 602. For example, the direct connection 612 may allow the transfer of energy, fluids, air, data, etc. between the drive component(s) 614 and the vehicle. In some instances, the direct connection 612 may further releasably secure the drive component(s) 614 to the body of the vehicle 602.

In some examples, the vehicle 602 may send sensor data and/or log data (e.g., data 640), which may comprise sensor data (e.g., sensor data 660) and/or log data associated with a vehicle operating in an environment to one or more computing device(s) 650 via the network(s) 616. In some examples, the vehicle 602 may send raw sensor data and/or log data (e.g., data 640) to the computing device(s) 650. In other examples, the vehicle 602 may send processed sensor data and/or log data and/or representations of sensor data and/or log data to the computing device(s) 650. In some examples, the vehicle 602 may send sensor data and/or log data to the computing device(s) 650 at a particular frequency, after a lapse of a predetermined period of time, in near real-time, etc. In some cases, the vehicle 602 may send sensor data (raw or processed) and/or log data to the computing device(s) 650 as one or more log files.

The computing device(s) 650 may include processor(s) 622 and a memory 624 storing an ML component 638, a communication component 860, and/or any other systems or components contemplated herein. For example, memory 624 may additionally or alternatively comprise resolution data 656 configured implement one of the techniques discussed herein. For example, resolution data 656 may be configured to determine resolution data applicable to or appropriate for any given sensor data (e.g., uncertainties) perceived by vehicle(s) operating in an environment. Resolution data 656 may, in some examples, store or house possible resolution data for any given scenario data (e.g., suggested actions, acceleration profile modification, trajectory modification, sensor data modification, object/obstacle identification or classification, selection of a possible response, and so on).

In some examples, memory 624 may additionally or alternatively comprise map data 658. Map data 658 may be a storage device or service remotely accessible to one or more vehicles, as discussed above. Additionally or alternatively, a remote operations system (which may comprise computing device(s) 650) may be communicatively coupled to or have access to map data 658. Map data 658 may be updated according to the techniques herein.

In examples, computing device(s) 650 may comprise sensor data 660, which may be transmitted (e.g., via one or more network(s) 616) from or determined by the sensor system(s) 606 of a vehicle 602.

In some examples, as discussed above, ML component 638 may comprise a scenario encoder 652 (e.g., scenario encoder 402) and/or a neural network 654 (e.g., neural network 406).

In some examples, vehicle 602 and/or computing device(s) 650 may comprise an ML component 638. In some examples, the ML component 638 may comprise a scenario encoder 652 and/or neural network 654 configured to implement one or more of the techniques discussed herein (e.g., determine similarities between sensor data perceived by different vehicles). For example, the computing device(s) 650 may receive log data that represents a sensor data perceived during a vehicle scenario and may employ a scenario encoder 652 to encode the sensor data into reduced-dimensionality scenario embeddings. The scenario encoder may be configured to encode (e.g., transform) log data records representing sensor data (e.g., from real-world, simulated, and/or hybrid environments) into reduced-size feature vectors, referred to herein as scenario embeddings. As noted above, the scenario encoder may comprise a pretrained foundation model used for general-purpose driving scenario encoding. In some cases, the scenario encoder may comprise a scenario encoder and separate scenario decoder, which may be trained jointly or independently to transform sensor data into scenario embeddings and vice versa. The scenario encoder may be implemented and/or trained based on any of the encoder/decoder architectures described herein. The ML component 638 may additionally or alternatively comprise a neural network 654 (e.g., a multi-layer perceptron) that may be associated with the scenario encoder (e.g., built on top of) and be configured to receive as input the scenario embedding output by the scenario encoder 652.

The scenario encoder 652 may comprise all or a portion of a foundation model (e.g., a masked autoencoder (MAE)) trained to encode and reconstruct sensor data associated with driving scenarios. In examples, the foundation model may be leveraged in various complementary ways, such as using the learned embedding space to group (e.g., cluster) qualitatively similar scenarios together, and fine-tuning the foundation model to label scenario difficulty (or detect scenario driving behaviors or other features). Scenario difficulty scores (e.g., behavior metrics scores) may be used as importance weighting for the groups of vehicle scenarios. In at least some examples, such techniques may cluster/group sensor data based on similarities/characteristics, which may be leveraged to extrapolate information about problematic or recurring uncertainties that may be addressed via updated map data or by proactively transmitting resolution data to other vehicle(s), for example.

For pretraining the foundation model (scenario encoder 402), a masked autoencoder (MAE) training objective may be adopted. For such pretraining, portions of the scenario input may be masked, after which the partially masked inputs may be encoded and decoded. A reconstruction loss may be computed between the decoder outputs and the original, unmasked inputs. In some examples, a sparse representation of the driving scenarios may be used rather than a birds-eye view (BEV) rendering, which may allow for a more high-resolution representation of the inputs and a natural use of the transformer architecture applied in the foundation model scenario encoder. For a more complete discussion of scenario encoder, see at least U.S. patent application Ser. No. 18/620,616, entitled “Estimating Driving Behavior Metrics Using Scenario Embeddings,” filed on Aug. 30, 2024, which is hereby incorporated by reference in its entirety and for all purposes.

In some examples, ML component 638 may further comprise a neural network 654 (e.g., multi-layer perceptron or other suitable neural network structure) configured to receive as input the scenario embedding(s) output by the scenario encoder and to determine similarities/differences between the scenario embedding(s). Although described herein generally as a neural network 654, an exemplary neural network is an algorithm which passes input data through a series of connected layers to produce an output. Each layer in a neural network may also comprise another neural network or may comprise any number of layers (whether convolutional or not). As may be understood in the context of this disclosure, a neural network may utilize machine learning, which may refer to a broad class of such algorithms in which an output is generated based on learned parameters.

Although discussed in the context of neural networks, any type of machine learning may be used consistent with this disclosure. For example, machine learning algorithms may include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, opfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

The processor(s) 618 of the vehicle 602 and the processor(s) 622 of the computing device(s) 650 may be any suitable processor capable of executing instructions to process data and perform operations as described herein. By way of example and not limitation, the processor(s) 618 and 622 may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

Memory 620 and 624 are examples of non-transitory computer-readable media. The memory 620 and 624 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 620 and 624 may include at least a working memory and a storage memory. For example, the working memory may be a high-speed memory of limited capacity (e.g., cache memory) that is used for storing data to be operated on by the processor(s) 618 and 622. In some instances, the memory 620 and 624 may include a storage memory that may be a lower-speed memory of relatively large capacity that is used for long-term storage of data. In some cases, the processor(s) 618 and 622 may not operate directly on data that is stored in the storage memory, and data may need to be loaded into a working memory for performing operations based on the data, as discussed herein.

It should be noted that while FIG. 6 is illustrated as a distributed system, in alternative examples, components of the vehicle 602 may be associated with the computing device(s) 650 and/or components of the computing device(s) 650 may be associated with the vehicle 602. That is, the vehicle 602 may perform one or more of the functions associated with the computing device(s) 650, and vice versa.

### Example Clauses

A: A system comprising: one or more processors; and a memory storing processor-executable instructions that, when executed by the one or more processors, cause the one or more processors to perform operations comprising: receiving, from a first vehicle at a first time, a request for guidance associated with an uncertainty in an environment perceived by the first vehicle; determining, based at least in part on the uncertainty, a suggested action to resolve the uncertainty; transmitting, to the first vehicle, the suggested action; receiving, from the first vehicle, a first indication that the suggested action resolved the uncertainty for the first vehicle; determining, based at least in part on a geolocation associated with a second vehicle operating in the environment, a likelihood that the second vehicle will perceive the uncertainty at a second time after the first time; transmitting, based at least in part on the first indication and the likelihood meeting or exceeding a threshold likelihood, the suggested action to the second vehicle at a third time before the second time; and updating, based at least in part on a second indication that the suggested action successfully resolved the uncertainty for the second vehicle, map data associated with the uncertainty.
B: The system of paragraph A, wherein transmitting the suggested action to the second vehicle is further based at least in part on determining that the first time and the third time are within a threshold duration.
C: The system of paragraph A or B further comprising: determining a time window associated with the suggested action and the uncertainty; and determining, based at least in part on the third time being within the time window, that the suggested action is valid, wherein transmitting the suggested action to the second vehicle is based at least in part on determining that the suggested action is valid.
D: The system of any of paragraphs A-C, the uncertainty being a first uncertainty, the operations further comprising: determining first context data associated with the first uncertainty; determining second context data associated with a second uncertainty perceived by a third vehicle operating in the environment; and determining, based at least in part on a similarity metric associated with the first context data the second context data, that the second uncertainty is associated with the first uncertainty, wherein transmitting the suggested action to the third vehicle is based at least in part on the similarity metric meeting or exceeding a threshold similarity metric.
E: The techniques of any of paragraphs A-D, further comprising: a method comprising: receiving, from a first vehicle, a confirmation request associated with first sensor data perceived in an environment; determining, based at least in part on the first sensor data, resolution data associated with the first sensor data; determining, based at least in part on context data associated with a second vehicle operating in the environment, a likelihood that the second vehicle will perceive second sensor data associated with the first sensor data; and transmitting, based at least in part on the likelihood, the resolution data to the second vehicle, wherein the second vehicle is configured to navigate the environment based at least in part on the resolution data.
F: The techniques of any of paragraphs A-E, further comprising: transmitting, to the first vehicle, the resolution data; and receiving, from the first vehicle, a first indication that the resolution data successfully resolved the first sensor data for the first vehicle, and wherein transmitting the resolution data to the second vehicle is further based at least in part on receiving the first indication.
G: The techniques of any of paragraphs A-F, the first indication being received at a first time and the resolution data being transmitted to the second vehicle at a second time, further comprising: determining a time window associated with the resolution data and the first sensor data; and determining, based at least in part on the first time and the second time being within the time window, that the resolution data is valid, wherein transmitting the resolution data to the second vehicle is based at least in part on determining that the resolution data is valid.
H: The techniques of any of paragraphs A-G, further comprising: updating, based at least in part on the first indication, map data associated with the second sensor data.
I: The techniques of any of paragraphs A-H, further comprising: determining, based at least in part on updated map data, a second likelihood that a third vehicle will perceive the second sensor data; and transmitting, based at least in part on the second likelihood, the resolution data to the third vehicle.
J: The techniques of any of paragraphs A-I, wherein the resolution data comprises at least one of: a trajectory modification, an acceleration profile modification, an instruction to avoid a geolocation associated with the first sensor data, a sensor data modification, and a selection of one or more options.
K: The techniques of any of paragraphs A-J, wherein transmitting the resolution data to the second vehicle is based at least in part on retrieving the resolution data from a remote computing resource configured to store resolution data associated with sensor data.
L: The techniques of any of paragraphs A-K, further comprising determining first context data associated with the first sensor data; determining second context data associated with the second vehicle; and determining, based at least in part on the first context data and the second context data, a similarity metric, wherein transmitting the resolution data to the second vehicle is based at least in part on the similarity metric meeting or exceeding a threshold similarity.
M: The techniques of any of paragraphs A-L, wherein the second context data is based on the second sensor data perceived by the second vehicle, wherein transmitting the resolution data to the second vehicle is further based at least in part on the second vehicle perceiving the second sensor data.
N: The techniques of any of paragraphs A-M, wherein the similarity metric is determined at least in part by a machine-learned (ML) model, configured to: receive as input context data associated with one or more vehicles operating in an environment, and output a similarity metric between context data associated with individual vehicles.
O: The techniques of any of paragraphs A-N, wherein the resolution data is transmitted to the first vehicle at a first time and to the second vehicle at a second time, and wherein transmitting the resolution data to the second vehicle is based at least in part on determining that the first time and the second time are within a threshold duration.
P: The techniques of any of paragraphs A-O, further comprising: one or more non-transitory computer-readable media storing processor-executable instructions that, when executed by one or more processors, cause the one or more processors to perform operations comprising: receiving, from a first vehicle, a confirmation request associated with first sensor data perceived in an environment; determining, based at least in part on the first sensor data, resolution data associated with the first sensor data; determining, based at least in part on context data associated with a second vehicle operating in the environment, a likelihood that the second vehicle will perceive second sensor data associated with the first sensor data; and transmitting, based at least in part on the likelihood, the resolution data to the second vehicle, wherein the second vehicle is configured to navigate the environment based at least in part on the resolution data.
Q: The techniques of any of paragraphs A-P, further comprising: transmitting, to the first vehicle, the resolution data; and receiving, from the first vehicle, a first indication that the resolution data successfully resolved the first sensor data for the first vehicle, and wherein transmitting the resolution data to the second vehicle is further based at least in part on receiving the first indication.
R: The techniques of any of paragraphs A-Q, the first indication being received at a first time and the resolution data being transmitted to the second vehicle at a second time, further comprising: determining a time window associated with the resolution data and the first sensor data; and determining, based at least in part on the first time and the second time being within the time window, that the resolution data is valid, wherein transmitting the resolution data to the second vehicle is based at least in part on determining that the resolution data is valid.
S: The techniques of any of paragraphs A-R, wherein the resolution data is transmitted to the first vehicle at a first time and to the second vehicle at a second time, and wherein transmitting the resolution data to the second vehicle is based at least in part on determining that the first time and the second time are within a threshold duration.
T: The techniques of any of paragraphs A-S, wherein the resolution data comprises at least one of: a trajectory modification, an acceleration profile modification, an instruction to avoid a geolocation associated with the first sensor data, a sensor data modification, and a selection of one or more options.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations, and equivalents thereof are included within the scope of the techniques described herein. In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
a memory storing processor-executable instructions that, when executed by the one or more processors, cause the one or more processors to perform operations comprising:
receiving, from a first vehicle at a first time, a request for guidance associated with an uncertainty in an environment perceived by the first vehicle;
determining, based at least in part on the uncertainty, a suggested action to resolve the uncertainty;
transmitting, to the first vehicle, the suggested action;
receiving, from the first vehicle, a first indication that the suggested action resolved the uncertainty for the first vehicle;
determining, based at least in part on a geolocation associated with a second vehicle operating in the environment, a likelihood that the second vehicle will perceive the uncertainty at a second time after the first time;
transmitting, based at least in part on the first indication and the likelihood meeting or exceeding a threshold likelihood, the suggested action to the second vehicle at a third time before the second time; and
updating, based at least in part on a second indication that the suggested action successfully resolved the uncertainty for the second vehicle, map data associated with the uncertainty.

2. The system of claim 1, wherein transmitting the suggested action to the second vehicle is further based at least in part on determining that the first time and the third time are within a threshold duration.

3. The system of claim 2 further comprising:
determining a time window associated with the suggested action and the uncertainty; and
determining, based at least in part on the third time being within the time window, that the suggested action is valid,
wherein transmitting the suggested action to the second vehicle is based at least in part on determining that the suggested action is valid.

4. The system of claim 1, the uncertainty being a first uncertainty, the operations further comprising:
determining first context data associated with the first uncertainty;
determining second context data associated with a second uncertainty perceived by a third vehicle operating in the environment; and
determining, based at least in part on a similarity metric associated with the first context data the second context data, that the second uncertainty is associated with the first uncertainty,
wherein transmitting the suggested action to the third vehicle is based at least in part on the similarity metric meeting or exceeding a threshold similarity metric.

5. A method comprising:
receiving, from a first vehicle, a confirmation request associated with first sensor data perceived in an environment;
determining, based at least in part on the first sensor data, resolution data associated with the first sensor data;
determining, based at least in part on context data associated with a second vehicle operating in the environment, a likelihood that the second vehicle will perceive second sensor data associated with the first sensor data; and
transmitting, based at least in part on the likelihood, the resolution data to the second vehicle,
wherein the second vehicle is configured to navigate the environment based at least in part on the resolution data.

6. The method of claim 5, further comprising:
receiving, from the first vehicle, a first indication that the resolution data successfully resolved the first sensor data for the first vehicle, and wherein transmitting the resolution data to the second vehicle is further based at least in part on receiving the first indication.

7. The method of claim 6, the first indication being received at a first time and the resolution data being transmitted to the second vehicle at a second time, further comprising:
determining a time window associated with the resolution data and the first sensor data; and
determining, based at least in part on the first time and the second time being within the time window, that the resolution data is valid,
wherein transmitting the resolution data to the second vehicle is based at least in part on determining that the resolution data is valid.

8. The method of claim 6, further comprising:
updating, based at least in part on the first indication, map data associated with the second sensor data.

9. The method of claim 8, further comprising:
determining, based at least in part on updated map data, a second likelihood that a third vehicle will perceive the second sensor data; and
transmitting, based at least in part on the second likelihood, the resolution data to the third vehicle.

10. The method of claim 5, wherein the resolution data comprises at least one of:
a trajectory modification,
an acceleration profile modification,
an instruction to avoid a geolocation associated with the first sensor data,
a sensor data modification, and
a selection of one or more options.

11. The method of claim 5, wherein transmitting the resolution data to the second vehicle is based at least in part on retrieving the resolution data from a remote computing resource configured to store resolution data associated with sensor data.

12. The method of claim 5, further comprising:
determining first context data associated with the first sensor data;
determining second context data associated with the second vehicle; and
determining, based at least in part on the first context data and the second context data, a similarity metric,
wherein transmitting the resolution data to the second vehicle is based at least in part on the similarity metric meeting or exceeding a threshold similarity.

13. The method of claim 12,
wherein the second context data is based on the second sensor data perceived by the second vehicle,
wherein transmitting the resolution data to the second vehicle is further based at least in part on the second vehicle perceiving the second sensor data.

14. The method of claim 13, wherein the similarity metric is determined at least in part by a machine-learned (ML) model, configured to:
receive as input context data associated with one or more vehicles operating in an environment, and
output a similarity metric between context data associated with individual vehicles.

15. The method of claim 5, wherein the resolution data is transmitted to the first vehicle at a first time and to the second vehicle at a second time, and wherein transmitting the resolution data to the second vehicle is based at least in part on determining that the first time and the second time are within a threshold duration.

16. A non-transitory computer-readable media storing processor-executable instructions that, when executed by one or more processors, cause the one or more processors to perform operations comprising:
receiving, from a first vehicle, a confirmation request associated with first sensor data perceived in an environment;
determining, based at least in part on the first sensor data, resolution data associated with the first sensor data;
transmitting, to the first vehicle, the resolution data;
determining, based at least in part on context data associated with a second vehicle operating in the environment, a likelihood that the second vehicle will perceive second sensor data associated with the first sensor data; and
transmitting, based at least in part on the likelihood, the resolution data to the second vehicle,
wherein the second vehicle is configured to navigate the environment based at least in part on the resolution data.

17. The non-transitory computer-readable media of claim 16, further comprising:
receiving, from the first vehicle, a first indication that the resolution data successfully resolved the first sensor data for the first vehicle, and wherein transmitting the resolution data to the second vehicle is further based at least in part on receiving the first indication.

18. The non-transitory computer-readable media of claim 17, the first indication being received at a first time and the resolution data being transmitted to the second vehicle at a second time, further comprising:
determining a time window associated with the resolution data and the first sensor data; and
determining, based at least in part on the first time and the second time being within the time window, that the resolution data is valid,
wherein transmitting the resolution data to the second vehicle is based at least in part on determining that the resolution data is valid.

19. The non-transitory computer-readable media of claim 16, wherein the resolution data is transmitted to the first vehicle at a first time and to the second vehicle at a second time, and wherein transmitting the resolution data to the second vehicle is based at least in part on determining that the first time and the second time are within a threshold duration.

20. The non-transitory computer-readable media of claim 16, wherein the resolution data comprises at least one of:
a trajectory modification,
an acceleration profile modification,
an instruction to avoid a geolocation associated with the first sensor data,
a sensor data modification, and
a selection of one or more options.
